(19) United States
(12) Patent Application Publication
(10) Pub. No.: US 2021/0400979 A1
(43) Pub. Date: Dec. 30, 2021

(54) ANTI-VIRAL FACE MASK AND FILTER MATERIALS

(71) Applicants: Isaac Angres, North Potomac, MD (US); Carlos Salazar Altamar, Barranquilla (CO)

(72) Inventors: Isaac Angres, North Potomac, MD (US); Carlos Salazar Altamar, Barranquilla (CO)

(21) Appl. No.: 16/912,815

(22) Filed: Jun. 26, 2020

(51) Int. Cl. A01N 55/02; A01N 25/34; A01N 25/30; D06P 5/30; A62B 23/02; B05D 3/02; D06M 13/503

(52) U.S. Cl. CPC A01N 55/02; A01N 25/34; A01N 25/30; D06M 2101/20; A62B 23/025; B05D 3/02; D06M 13/503; D06P 5/30

(57) ABSTRACT

The invention provides a filter fabric for providing anti pathogenic properties which has been coated with a composition comprising (a) 0.0001-99.9999% by weight of a compound of such as zinc pyrithione and (b) 0.0001-99.9999% by weight of an additional zinc salt selected from the group consisting of zinc acetate, zinc propionate, zinc oxalate, zinc benzoate, zinc gluconate, zinc ascorbate, zinc citrate, zinc lactate, zinc glycolate, zinc maleate, zinc fumarate, zinc polyacrylate and zinc polymaleate. The invention also provides a composition for imparting anti-viral properties to a breathable substrate material comprising two or more zinc salts selected from the group consisting of zinc acetate, zinc propionate, zinc oxalate, zinc benzoate, zinc gluconate, zinc ascorbate, zinc citrate, zinc lactate, zinc glycolate, zinc maleate, zinc fumarate, zinc EDTA, zinc glycinate, zinc polyacrylate, zinc polylactate, zinc polyglycolate and zinc polymaleate said zinc salts being present in effective amounts to impart anti-pathogenic properties.

### FIELD OF THE INVENTION

The present invention relates generally to the field of medicine and more specifically to infectious diseases. The invention also relates to a method for coating a substrate with an anti-pathogenic agent to render the substrate suitable for use as a barrier against pathogens. The instant invention also relates to face masks incorporating the coated substrate as one of the layers.

This invention also further relates to a novel device being an oral and/or nasal air filter able to remove and neutralize harmful virus from inhaled air contaminated with such virus, and from contaminated air exhaled from patients infected with such virus. In particular the invention relates to such a device in the form of a face mask. The invention also relates to novel filter materials suitable for use in such a device.

This invention also concerns a face mask and a method for destroying bacteria and viruses which may travel in either direction with air inhaled or exhaled through the mask. In particular, the invention concerns a face mask which is porous in structure and contains, either disposed within an outer or central layer of the mask or a porous sheet material attached to the outer surface of the mask, a chemical, such as zinc salts, which is capable of destroying biological agents, such as microbes and viruses, which pass into the mask and flow either therethrough or through a porous attachment to the mask.

Additionally, this invention also relates to HEPA filters for removing pathogens from the air and, more particularly, to a glass based filter for killing, absorbing and removing pathogens in the air.

The present disclosure is also directed, in general, to air filtration and purification for heating ventilation and air conditioning (HVAC) systems and, more particularly, to a anti-pathogenic air filtration media for air purification.

The present invention also relates, in general, to air purifiers and, more particularly, to an air purifier for use in providing clean air by removing dust, bacteria, viruses and contaminants in air.

The invention is further related to medical fabrics, such as those used to prepare surgical gowns, drapes, masks and dressings. In another aspect, the invention relates to porous materials such as those used to prepare filters, membranes, and the like. In yet another aspect, the invention relates to materials and methods for the inactivation of microbial pathogens such as viruses, and in particular, to the inactivation of corona viruses.

### BACKGROUND OF THE INVENTION

The problem of preventing and combating the massive spread of acute respiratory infections due to the lack of effectiveness of modern remedies remains relevant. More in particular, the pathogen transfer in the form of fine droplets of biological fluid resulting from talking, sneezing or coughing make contact with an infected object (for example: patient—doctor, patient—healthy) is potentially dangerous.

Antimicrobial coatings have been a subject of many investigations. Micro-organisms such as bacteria, viruses, fungi, mould and mildew deposited on surfaces can cause sickness and death in humans. These micro-organisms can cause sneezing and coughing, as well as major respiratory illnesses that may cause death. A surface can be temporarily sterilized with disinfectants; however, effective and durable antimicrobial surfaces are desirable.

There are a variety of infectious human diseases, such as human respiratory tract infections, that are caused by human pathogens such as bacteria, fungi and viruses. For example, viral causes of infectious human diseases (and their associated diseases) include: Influenza A virus (including ‘swine flu’ such as the 2009 H1N1 strain); Influenza B-C virus (coryza; ‘common cold’); Human adenovirus A-C (various respiratory tract infections; pneumonia); Human Para-influenza virus (coryza; ‘common cold;’ croup); Mumps virus (epidemic parotitis); Rubeola virus (measles); Rubella virus (German measles); Human respiratory syncytial virus (RSV) (coryza; ‘common cold’); Human coronavirus (SARS virus) (SARS); Human rhinovirus A-B (coryza; ‘common cold’); parvovirus B19 (fifth disease); variola virus (smallpox); varicella-zoster virus (herpes virus) (chickenpox); Human enterovirus (coryza; ‘common cold’); Bordetella pertussis (whooping cough); Neisseria meningitidis (meningitis); Corynebacterium diphtherias (diphtheria); Mycoplasma pneumoniae (pneumonia); Mycobacterium tuberculosis (tuberculosis); Streptococcus pyogenes/pneumoniae (strep throat, meningitis, pneumonia); and Haemophilus influenzae Type B (epiglottis, meningitis, pneumonia).

Many of the human respiratory tract infections result in significant morbidity and mortality. For example, seasonal epidemics of influenza viruses worldwide infect an estimated 3 million to 5 million people, and kill between 250,000 to 500,000 people each year. In addition, cyclical influenza virus pandemics occur, such as the influenza outbreak in 1918 which killed between 20 million and 50 million people worldwide.

Among the modes of transmission of these infectious human diseases are by airborne transmission of infectious particles expelled from the respiratory tract of an infected person by coughing or sneezing, or by simple exhalation, and into the gastrointestinal or respiratory systems of a previously non-infected person by inhalation. To combat this form of transmission, facial masks have been developed that either mechanically intercept the infectious particles, or that inactivate the infectious particles, or both mechanically intercept the infectious particles and inactivate the infectious particles, by a variety of mechanisms.

Additionally, Severe Acute Respiratory Syndrome (SARS) CoV-2 (Covid19) virus is a disease that emerged in Asia and resulted in an epidemic that had devastating health and economic effects. The disease spread rapidly from infected patient to infected patient, including numerous health care workers. Because the disease is so infectious, it is important to develop effective personal protective equipment to provide good protection to health care workers as well as the population as required.

Severe acute respiratory syndrome (SARS Cov-1 and Cov-2) are relatively new potentially life threatening infectious disease of humans. After SARS Cov-1 and SARS Cov-2 were first recognized in late February 2003 in Hanoi, Vietnam, and in December 2019 in Wuhan, China respectively, the disease spread rapidly, with cases reported from all over the world on five continents over many months (World Health Organization. Severe acute respiratory syndrome (SARS I. Wkly. Epidemiol. Rec. 2003, 78:81-3; Peiris, et al. Coronavirus as a possible cause of severe acute respiratory syndrome. Lancet 2003, 361:1319-25; Lee, et al. A major outbreak of severe acute respiratory syndrome in Hong Kong. N. Eng. J. Med. 2003, 348:1986-94; Tsang, et al. A cluster of cases of severe acute respiratory syndrome in Hong Kong. N. Eng. J. Med. 2003, 348:1977-85; Poutanen, et al. Identification of severe acute respiratory syndrome in Canada. N. Eng. J. Med. 2003, 348:1995-2005; Kuiken, et al. Newly discovered coronavirus as the primary cause of severe acute respiratory syndrome. Lancet 2003, 362:263-70; World Health Organization Multicentre Collaborative Network for Severe Acute Respiratory Syndrome (SARS) Diagnosis and A multicentre collaboration to investigate the cause of severe acute respiratory syndrome. Lancet 2003, 361:1730-3). By Jul. 3, 2003, this epidemic resulted in 8,439 reported cases globally, of which 812 were fatal (Cumulative number of reported probable cases of severe acute respiratory syndrome (SARS). e-publication cited Jul. 8, 2003) and Zhu N, Zhang D, Wang W, Li X, Yang B, Song J, et al. A Novel Coronavirus from Patients with Pneumonia in China, 2019. N Engl J Med. 2020 Jan. 24.

The most common early symptoms of SARS both Cov-1 and Cov-2 include fever (a measured temperature greater than 100.4(F. (38.0(C.)), chills, headache, myalgia, dizziness, rigors, cough, sore throat, and runny nose (WHO Weekly Epidemiological Record, No. 12, Mar. 21, 2003). The SARS illness usually starts with fever, severe headache, dizziness, and myalgia. After 2 to 7 days, SARS patients generally develop a dry, nonproductive cough. In some cases, there may be rapid deterioration of conditions, with low oxygen saturation and acute respiratory distress.

The SARS-associated coronaviruses COv-1 and Cov-2 pathogens were quickly isolated, and their genomes have been sequenced by scientists in China, Canada and the United States (Ksiazek et al., A novel coronavirus associated with severe acute respiratory syndrome. N. Engl. J. Med., Apr. 10, 2003, e-pub; Drosten et al., Identification of a novel coronavirus in patients with severe acute respiratory syndrome. N. Engl. J. Med., Apr. 10, 2003, e-pub; WHO Update 31, Coronavirus never before seen in humans is the cause of SARS, Apr. 16, 2003) and Lu, R. et al. Genomic characterization and epidemiology of 2019 novel coronavirus: implications for virus origins and receptor binding. Lancet, doi:10.1016/50140-6736(20)30251-8 (2020). Rapid identification of the causal agent as a novel coronavirus (SARS-CoV-1) represents an extraordinary achievement in the history of global health and helped to contain the epidemic (World Health Organization Multicentre Collaborative Network for Severe Acute Respiratory Syndrome (SARS) Diagnosis. A multicentre collaboration to investigate the cause of severe acute respiratory syndrome. Lancet 2003 361:1730-3). Nonetheless, the epidemiology and pathogenesis of SARS for Cov-1 and Cov-2 remain poorly understood, and definitive diagnostic tests or specific treatments are not established. Since the origin of the virus and its animal reservoirs remain to be defined, the potential for recurrence is unknown.

The coronaviruses that has been implicated in SARS Cov-1 and Cov-2 represents the prototype of a new lineage of coronaviruses capable of causing outbreaks of clinically significant and frequently fatal human disease. Coronaviruses were first isolated from chicken in 1937, and from human in 1965. The coronavirus family contains approximately 15 species, which infect a broad range of animals, including humans, cats, dogs, cows, pigs, rodents, and birds (e.g., chickens, batts). The coronavirus is a single-stranded, (+)sense RNA virus. The virus enters the host cell via endocytosis, and reproduces itself in the cytoplasm; no DNA stage is involved. New virions form by budding into the Golgi apparatus, being transported to the cell surface, and secreted from host cell.

Additionally, in the past century three pandemics of Influenza have been witnessed, of which the “Spanish flu” of 1918 was the largest pandemic of any infectious disease known to medical science (Oxford, J. S., 2000). The three strains which caused these pandemics belong to group A of the influenza virus and, unlike the other two groups (B and C), this group infects a vast variety of animals (poultry, swine, horses, humans and other mammals). Influenza A virus continue to cause global problems, both economically and medically (Hayden, F. G. & Palese, P., 2000). The current global concern is the avian Influenza A H5N1 virus, which first demonstrated its ability to infect birds in China in 1997 and has since spread to other countries in South East Asia, Europe and Africa (Enserink, M, 2006: Guan, Y. et al., 2004; Peiris, J. S. et al., 2004). Its ability to cause severe disease in birds was documented by the World Health Organisation during a mild outbreak in South East Asian birds during 2003-2004. H5N1 mutates rapidly and is highly pathogenic. Its co-existence with other avian influenza virus increases the likelihood of concurrent infections in birds. Such events would provide the ‘mixing vessel’ for the emergence of a novel subtype with sufficient avian genes to be easily transmitted between avian species, which would mark the start of an influenza epidemic (WHO Fact sheet).

Much has been done to control and prevent another pandemic from occurring with many anti-influenza products (vaccines and treatments) currently on the market. Presently, Amantadine is the principal antiviral compound against Influenza infections, but its activity is restricted to Influenza A virus. Anti-neuraminidase inhibitors, such as Zanamivir (Relenza) and Oseltamivir (Tamiflu), are a new class of antiviral agents licensed for use in the treatment of both Influenza A and B infections (Carr, J., et al., 2002). The role of these antivirals in a pandemic may be limited due to the time and cost involved in production and the current limited supply. With the recent news of a probable H5N1 pandemic the need to prevent any opportunities of transmission of the virus between avian species has risen.

The inhalation of air contaminated by harmful virus and/or other micro-organisms is a common route for infection of human beings, particularly health workers and others caused to work with infected humans or animals. Air exhaled by infected patients is a source of contamination. At the present time the risk of infection by the so called “bird flu” H5N1 virus as well as the coronaviruses Cov-1 and Cov-2 is of particular concern. Masks incorporating a suitable filter material would be ideal for use as a barrier to prevent species-to-species transmission of the virus.

Air filters believed to remove such virus and/or other micro-organisms are known. One type of such a filter comprises a fibrous or particulate substrate on which is deposited, upon the surface and/or into the bulk of such fibres or particles, a substance which captures and/or neutralizes virus and/or other micro-organisms of concern.

Additionally, face masks find utility in a variety of medical, industrial and household applications by protecting the wearer from inhaling dust and other harmful airborne contaminates through their mouth or nose. The use of face masks is a recommended practice in the healthcare industry to help prevent the spread of disease. Face masks worn by healthcare providers help reduce infections in patients by filtering the air exhaled from the wearer, thus reducing the number of harmful organisms or other contaminants released into the environment. Additionally, face masks protect the healthcare worker by filtering airborne contaminants and microorganisms from the inhaled air.

The section of the face mask that covers the nose and mouth is typically known as the body portion. The body portion of the mask may be comprised of several layers of material. At least one layer may be composed of a filtration material that prevents the passage of germs and other contaminants therethrough but allows for the passage of air so that the user may comfortably breathe. The porosity of the mask refers to how easily air is drawn through the mask and a more porous mask is, of course, easier to breathe through. The body portion may also contain multiple layers to provide additional functionality for the face mask. Face masks may, for example, include one or more layers of material on either side of the filtration material layer. Further components may be attached to the mask to provide additional functionality.

The recent outbreak of severe acute respiratory syndrome (SARS Cov-1 and Cov-2)) has elevated interest in a germicidal mask which will deactivate microbes and viruses contacting a face mask so that they are not inhaled by a wearer and so that they are not transferred to another surface by inadvertent contact of the mask on other surfaces or the hands.

Protective facial masks are designed to be worn by both the infected person to prevent transmission of infection, and by the non-infected person to prevent being infected. In order to keep the costs of production reasonable, facial masks generally are produced in only a few sizes or only one size. The problem with using conventional facial masks produced in a few sizes or only one size, however, is that the facial masks tend not to fit a substantial portion of the human population sufficiently tight around the face, and in particular around the nose of the wearer to prevent near complete ingress or egress of the airborne infectious particles. To address this deficiency, facial masks have been designed to incorporate mechanical structures, such as elastic bands that loop around the ears to seal the facial mask against the face of the wearer by increasing the force that holds the facial mask in place, thereby deforming the perimeter of the facial mask to more tightly fit the face of the wearer. While mitigating the problem, these mechanical structures create an unpleasant sensation of pressure for the wearer over time, and tend to limit the period that the facial mask can be worn. This is especially true for children who have a lower tolerance of discomfort. Additionally, conventional facial masks do not inactivate a substantial portion of the infectious particles that ingress between the facial mask and the face of the wearer.

Therefore, there is a need for a new protective facial mask that addresses these problems. Furthermore, there is a long felt need for better filter fabrics to prevent spread and infection of Coronaviruses Cov-1 and Cov-2. Also, there is a need to develop a means for preventing the transmission of infectious diseases by airborne droplets.

### OBJECTS OF THE INVENTION

It is, therefore, an object of the subject invention to provide an anti-pathogenic coating to a medical-type substrate in a commercially viable manner.

Another object of the invention is to provide a polypropylene-based fabric coated with a composition according to the present invention.

Still another object of the invention is to provide a polypropylene-based material comprising a plurality of layers, where one or more than one of the plurality of layers comprises a polypropylene-based fabric according to the present invention.

A still further object of the invention is to provide a device that decreases the transmission of one or more than one human pathogen by antibacterial, antifungal and antiviral activity. The device comprises a polypropylene-based fabric or a polypropylene-based material according to the present invention.

It is a further object of the invention, in a preferred embodiment thereof, to provide the anti-pathogenic coating in the form of a single or multilayered coating.

Another object of the invention is to provide filtering materials that have been coated with the anti-pathogenic compositions of the invention.

An additional object of the invention is to provide filtering materials that have been coated with the compositions of the invention to impart anti-viral properties.

A still further object of the invention is to provide HEPA filters that have been coated with the anti-pathogenic compositions of the invention.

An additional object of the invention is to provide face masks having anti-pathogenic properties.

A still further object of the invention is to provide a facial mask that decreases the transmission of one or more than one human pathogen by antibacterial, antifungal and antiviral activity. The facial mask comprises a polypropylene-based fabric or a polypropylene-based material according to the present invention.

A further object of the invention is to provide face masks having anti-viral properties.

Another object of the invention is to provide a filter fabric capable of removing viruses such as coronaviruses.

A still further object of the invention is to provide a process for permanently fixing zinc compositions in the molecular structure of cellulosic, proteinaceous, polypropylene woven and nonwoven fabrics as well as other organic materials such as, for example, paper, cotton, linen, rayon, wool, silk, natural bristles, hides, cellulcs'c sheets and films, sponges, casein fibers and films, gelatin in foam or film, form; and various thermoplastic materials The invention also provides novel chemical compositions for use in such processes.

### BRIEF DESCRIPTION OF THE FIGURES

FIG. 1 shows a section through the filtering material of the invention in a three layer configuration.

FIG. 2 is a schematic of the process and apparatus for coating a non-woven web with the antiviral composition.

FIG. 2A is an exemplary process for application of a treatment composition of the present invention to one or both sides of a traveling web.

FIG. 2B illustrates an alternative arrangement related to the FIG. 2 embodiment and method of applying a treatment composition of the present invention.

FIG. 3 is a schematic of the process and apparatus for coating a non-woven web with the antiviral composition using inkjet printing technology.

FIG. 3A is a perspective view showing one example of a continuous inkjet printing apparatus including the pretreating method using the inkjet according to the present invention.

FIG. 4 shows a schematic of inkjet coating ink with an inkjet print head.

FIG. 5 shows the different printing/coating configurations that could be done using inkjet coating technology.

FIG. 6 is a schematic illustration of an exemplary method of making a face mask according to the present disclosure.

FIG. 7 is a perspective view of an embodiment of an antiviral mask according to the present invention.

FIG. 8 is a perspective view of another antiviral mask according to the present invention.

FIG. 9 is a partial, frontal perspective view of a fabric according to the present invention.

FIG. 10 is a partial, cutaway, frontal perspective view of a material according to the present invention, comprising the fabric shown in FIG. 9 10, and comprising three layers.

FIG. 11 is a prospective view of a disposable face mask incorporating still another embodiment of the present invention illustrated on the head of a wearer.

FIG. 12 is a front plan view of the mask shown in FIG. 11.

FIG. 13A features the incorporation of [α-³²P]CMP into viral RNA SARS-CoV (B) in RTC assays in the presence of various Zn²⁺ concentrations, as indicated above each lane.

FIG. 13B shows the effect of pyrithione (PT) and Zn²⁺ and zinc acetate on the GFP fluorescence in Vero-E6 cells infected with a GFP-expressing SARS-CoV reporter strain.

FIG. 14 shows a commercial apparatus used to make masks using three rolls of fabrics.

FIG. 15 is another commercially available fully automated apparatus for manufacturing masks.

FIG. 16 is a cross section of a mask having a middle layer having the zinc compositions of the invention.

FIG. 17 shows a typical 96-well plate layout.

FIG. 18 shows graphically the percentage reduction in viral titre.

### SUMMARY OF THE INVENTION

The present invention relates to antiviral techniques making use of novel zinc compositions having the effect of inactivating respiratory viruses. More particularly it relates to antiviral nonwoven and woven filtering fabrics and antiviral masks and HEPA like filters made from the fabrics which can prevent infectious respiratory viruses from entering the mask wearer's system from the mouth and/or the nose by trapping the viruses floating in the air at a high rate and inactivating the trapped viruses. Additionally, the invention relates to an antiviral filter fabrics which are capable of trapping the viruses floating in the ambient air at a high rate and inactivating the trapped viruses to clean the air. The filter fabrics of the invention may also include antifungal and antibacterial substances which can trap fungi and bacteria floating in the air to kill or inactivate the trapped fungi and bacteria thereby to clean the air; an air cleaner; and an air cleaner comprising said filter fabrics.

The invention provides zinc salts containing composition for coating a polypropylene-based fabric or polypropylene-based material, such as for example a fabric or a material according to the present invention for use in decreasing the transmission of the human pathogens. In one embodiment, the composition decreases the hydrophobicity of the polypropylene-based fabric or polypropylene-based material, thereby increasing the transmission of the human pathogens through the polypropylene-based fabric or polypropylene-based material. In another embodiment, the composition has additional direct antibacterial, antifungal and antiviral activity. The composition provides a durable coating that adheres to the polypropylene-based fabric or polypropylene-based material. The composition is compatible with high-speed manufacturing processes such as the ultrasonic shaping and welding of protective face masks that comprise thermoplastic polypropylene-based fabric or polypropylene-based material. In a preferred embodiment, the composition is coated onto the surface of the polypropylene-based fabric or polypropylene-based material. In a preferred embodiment, the composition is coated onto one or more layers of the polypropylene-based material.

The invention provides a composition for imparting anti-pathogenic properties to a breathable substrate material comprising: (a) 0.0001-99.9999% by weight of a compound of the formula I

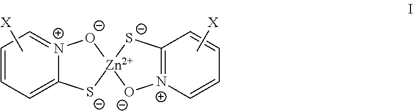

where X is a substituent at any carbon in the pyridine ring selected from the group consisting of H, C₁-C₅ alkyl, C₁-C₅ alkoxy, F, Cl, Br and I; and (b) 0.0001-99.9999% by weight of an additional zinc salt selected from the group consisting of zinc acetate, zinc propionate, zinc oxalate, zinc benzoate, zinc gluconate, zinc ascorbate, zinc glycinate, zinc citrate, zinc maleate, zinc fumarate, zinc polyacrylate, zinc polylactate, zinc polyglycolate and zinc polymaleate.

The invention further provides a composition for imparting anti-viral properties to a breathable substrate material comprising two or more zinc salts selected from the group consisting of zinc acetate, zinc propionate, zinc oxalate, zinc benzoate, zinc gluconate, zinc ascorbate, zinc citrate, zinc maleate, zinc glycinate, zinc fumarate, zinc salts of omega fatty acids, zinc EDTA (Ethylene diamine tetraacetic acid), zinc polyacrylate and zinc polymaleate said zinc salts being present in effective amounts to impart anti-pathogenic properties.

The invention also provides a method of imparting anti-pathogenic properties to a face mask substrate material comprising: (a) preparing a first coating composition containing a primer solution comprising a nonionic surfactant, and a solvent, and having a percent solids ranging from about 10 percent to about 50 percent; (b) applying said first coating to a surface of a substrate; (c) preparing a second coating composition comprising: (a) 0.0001-99.9999% by weight of a compound of the formula I

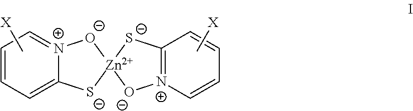

where X is a substituent at any carbon in the pyridine ring selected from the group consisting of H, C₁-C₅ alkyl, C₁-C₅ alkoxy, F, Cl, Br and I; and (b) 0.0001-99.9999% by weight of an additional zinc salt selected from the group consisting of zinc acetate, zinc propionate, zinc oxalate, zinc benzoate, zinc gluconate, zinc ascorbate, zinc glycinate, zinc citrate, zinc maleate, zinc fumarate, zinc polyacrylate and zinc polymaleate; and wherein said coating composition comprising (a) and (b) has a solids content ranging from about 0.0001% percent to about 50% by weight; (d) applying said second coating composition as a top coat over said first coating composition on said substrate; and (e) drying the coated substrate material.

The present invention also relates to a method for coating a substrate with an anti-pathogenic agent to render the substrate suitable for use as a barrier against pathogens. Specifically, the invention provides a method for coating a range of substrates with an anti-pathogenic agent such that in the dry state the substrate acts as a barrier to block the progress of pathogens and in the wet state the substrate coating is activated to release the anti-pathogenic agent and eliminate pathogens upon contact thereof with the agent. The coating may also take the form of a dual layered or multilayered coating. The invention further relates to various methods of coating substrates and to the products produced according to the methods.

The invention also provides an air-permeable mask of a shape suitable to be placed over a user's mouth and nose and to sealingly contact the user's face, provided with means to hold the mask in place on the user's face, and comprising one or more layer of a filter material positioned such that inhaled and/or exhaled air of the user passes through the filter material, wherein the filter material comprises an air permeable substrate coated with the anti-pathogenic composition described as above.

The instant invention is further directed to a face mask, comprising: a body portion configured to be placed over a mouth and at least part of a nose of a user in such that respiration air is drawn through said body portion, wherein said body portion comprises an outer layer having incorporated the compositions described above, in an effective amount to impart anti-pathogenic properties.

The also relates to a method of coating or printing a textile by applying an inkjet printer, the method comprising: (a) feeding a fabric by a fabric feed roller; (b) selecting, through a control unit, at least one pretreatment liquid component to be applied from a plurality of pretreatment liquid components installed in a pretreatment liquid reservoir, depending upon a type of the fed fabric, and determining, through the control unit, an application ratio of the selected at least one pretreatment liquid component; (b) controlling, by the control unit, a pretreatment head such that the selected at least one pretreatment liquid component is mixed based on the determined application ratio and is applied to the fed fabric, wherein an application amount of the selected at least one pretreatment liquid component or a frequency at which the selected at least one pretreatment liquid component applied to the fabric is adjusted depending upon the type of the fed fabric; (c) drying the selected at least one pretreatment liquid applied to the fabric through a dryer; and (d) coating or printing on the dried fabric by jetting an ink installed in an ink reservoir through a printing head.

The invention also relates to a method of coating or printing anti-pathogenic substances on a non-woven fabric to impart anti-pathogenic properties by using an inkjet printer, the method comprising: feeding a fabric by a fabric feed roller; selecting, through a control unit, at least one pretreatment liquid component to be applied from a plurality of pretreatment primer liquid components installed in a pretreatment liquid reservoir, depending upon a type of the fed fabric, and determining, through the control unit, an application ratio of the selected at least one pretreatment liquid component; controlling, by the control unit, a pretreatment head such that the selected at least one pretreatment primer liquid component is mixed based on the determined application ratio and is applied to the fed fabric, wherein an application amount of the selected at least one pretreatment primer liquid component or a frequency at which the selected at least one pretreatment primer liquid component applied to the fabric is adjusted depending upon the type of the fed fabric; drying the selected at least one pretreatment primer liquid applied to the fabric through a dryer; and coating or printing on the dried fabric by jetting an anti-pathogenic ink installed in an ink reservoir through a printing head.

The present invention also provides improved protection against the transmission of viruses in the course of contact between patients and health care workers, as well as protection against contact with viruses in the environment. The antiviral zinc composition is coated onto the fabric. Preferably, the fabric is inherently absorbent in order to facilitate the passage of the virus into the material. Once inside the fabric, the virus can be exposed to and inactivated by the zinc composition. The present invention provides a means for rendering otherwise nonwettable fabrics (e.g., nonwoven polyolefins) wettable and absorbent as well as antiviral. In certain embodiments, the fabric is provided with an impermeable barrier backing, e.g., a laminated backing.

The subject invention also relates to a process for producing substrates coated with a formulation containing a novel anti-pathogenic component. Upon contact of the coated substrate with a pathogen-containing material, the anti-pathogenic component is released to eliminate any pathologic affect of the pathogen. The invention further relates to the preparation of the anti-pathogenic-containing formulation, whether as a single composition or as a dual or multilayered coating, to the coating process, and to products or articles prepared from the coated substrates and their use.

The present invention also incorporates an anti-viral composition into a material or fabric intended for use in medical applications to guard against the transfer of contagious and potentially lethal viruses. The incorporation of such agents has been accomplished by coating the outer surface of the material, by interply coating of multi-ply fabric or material, or by chemically incorporating the coating agent into the material at the time of production.

The present invention also provides a mask, suitable for wearing, that inhibits or prevents the passage of active viruses and live germs there through and kills the virus. Briefly, the mask comprises a number of individual layers, at least some of which are substrates for a virucidal composition. Certain layers are treated with one or more of the inventive compositions effective for inactivating or destroying viruses and germs, particularly respiratory viruses, thus retarding or preventing the passage of live viruses and germs to the next layer, and ultimately to the user.

This invention further relates to nonwoven, woven or knit textiles, fibers and yarns (collectively, “textiles”) treated with a chemical composition that inhibits the growth of pathogenic microbes by depriving them of the nutrients needed to sustain growth. Alternatively, the treating composition of the invention can be applied to products manufactured from the textiles. The treated textiles of the invention desirably remain effective for deterring or inhibiting infectious microbial growth following repeated commercial washing cycles. Examples of products that can be made from textiles treated in accordance with the invention include, for example, garments, underwear, linens, blankets, curtains, towels, facial masks, washcloths, furniture coverings, seat coverings, table cloths, aprons and towels used in medical and dental facilities, schools, publicly used buildings, food preparation areas, public transportation, and the like. A novel tear-away hospital gown that comprises the treated textile of the invention, provides better anatomical coverage and quick access to a patient's frontal anatomy (especially while lying on a hospital bed or gurney) is also disclosed.

The present invention provides a fabric for use in decreasing the transmission of human pathogens. The fabric comprises two or more zinc salts that prevents replication of more than one type of human pathogen. The fabric comprises two or more than one zinc salts that prevents replication of more than one type of virus, such as influenza virus, that causes human respiratory tract infections such as influenza. By preventing replication of the human pathogen when in contact to the fabric, the fabric decreases the transmission of the human pathogen, such as for example by preventing release of virus particles when virus-laden droplets evaporate within the fabric.

The invention also relates to multilayer masks where each fabric layer has anti-pathogenic coatings in increasing or decreasing concentration across the layers of fabrics or concentrations in other fashion i.e., the middle layer has higher concentration that outer layer or the inner layer closer to the skin. A suitable layered construction utilizing the fabrics of the invention has an outer layer having 10-15% by weight of the antiviral compositions of the invention containing mixtures of zinc compounds, then an inner fabric material containing the zinc compositions of the invention, such as a non-woven polypropylene material which in use is against the user's skin containing 1-5% by weight of the compositions of the invention, and an optional outer layer also of a non-woven polypropylene material also containing 5-10% by weight of the compositions of the invention. There may be plural layers all containing the zinc compositions of the invention. The three layers contain the zinc compositions of the invention either in decreasing amounts from front to back, or vices versa and also the middle layer having the highest concentration by weight of the zinc compositions of the invention.

### DETAILED DESCRIPTION OF THE INVENTION

As used in this disclosure, except where the context requires otherwise, the term “comprise” and variations of the term, such as “comprising,” “comprises” and “comprised” are not intended to exclude other additives, components, integers or steps.

All dimensions specified in this disclosure are by way of example of one or more than one embodiment of the present invention only and are not intended to be limiting. As will be understood by those with skill in the art with reference to this disclosure, the actual dimensions of any device or part of a device disclosed in this disclosure will be determined by its intended use.

As used herein, the term “coated substrate” refers to any substrate which ultimately, in finished form, contains the anti-pathogenic component, whether the component is coated on the surface of the substrate, is imbedded in the substrate during substrate production, is coated as a single composition or in a dual or multilayered design, or is included in the finished substrate in another manner, as described hereinafter.

The term “multilayer design” or “multilayer format”, as used hereinafter, refers to a coating design wherein the coating components are situated in two or more layers. The various layers may be adjacent one another, or may be otherwise situated, i.e., one or more layers may be coated on a first side of the substrate and an other or other layers coated on the opposite side of the substrate. Further, active ingredient components may be contained in one or more of the various coating layers.

Also, the term “pathogen” and “pathogenic properties” in its various forms is used herein to mean and include such terms as viral, bacterial, fungal and HIV. Therefore, reference to an “anti-pathogen” or “anti-pathogenic property/activity” includes reference to anti-viral, anti-bacterial, anti-fungal and/or anti-HIV compositions and their anti-viral, anti-bacterial and/or anti-HIV activity. The term is used to refer to the use of the subject formulation, coated on an appropriate substrate, to neutralize or eliminate the undesirable affects of a pathogen by protecting against contact with the pathogen and further, upon contact with bodily fluids and/or skin, by eliminating the pathogenic activity. In a preferred embodiment, the term refers to a multilayered coating design which effectively protects against the transmission of tuberculosis, as well as other viral and bacterial infection.

Additionally, as used in this disclosure, “human pathogen” comprises bacteria, fungi and viruses, or other microorganisms that cause human diseases, including bacteria, fungi and viruses or other microorganisms that cause human respiratory tract infections.

As used in this disclosure, “flap” means a piece of the facial mask that when folded over at the body-flap junction toward the back surface of the body of the facial mask, inverts the layers of the material of the flap with respect to the layers of material of the body. Therefore, a pleat in a conventional facial mask is not a “flap” within the meaning of the present disclosure, because no such inversion of the layers of the material occur no matter how the pleats are opened or closed during use of the conventional facial mask.

As used in this disclosure, a material comprises a plurality of layers, such as a layer of fabric according to the present invention.

As used in this disclosure, “resilient member” means a substrate that readily regains its original shape after compression, where the resilient member has a first thickness before the application of a compressive force, a second thickness after the application of the compressive force, and a third thickness after the cessation of the application of the compressive force, where second thickness is 75% or less of the first thickness, and where the third thickness is between 90% and 100% of the first thickness, where the thicknesses can be measured at any location across the substrate.

“Virus contacting article” will refer to an article intended or expected to be exposed to or come into physical contact with a virus such as a surface borne, liquid borne or air borne virus particle. Typically such an article will be used, at least in part, for protective purposes, and will be expected to inactivate viruses retained within the article.

“Fabric substrate” will refer to a flexible porous material (e.g., woven or nonwoven fabric, filter, or membrane) capable of being fabricated into a virus contacting article and also capable of being coating with the zinc coating composition of the present invention.

Reducing the spread of viruses and bacteria could thwart the spread of respiratory infections, influenzas and coronaviruses pandemics. By protecting the user's nose and mouth so that microorganisms are inactivated or destroyed before they enter the user, or conversely, before the germs can be dispersed into the general population, the spread of these microbes can be significantly reduced.

A protective respirator, suitable to be easily worn as a mask, allows the users to reduce their potential exposures to infectious microorganisms. In one embodiment, a semi-rigid mask having a shape similar to that of a dust mask is utilized. In a second embodiment, a more flexible mask, similar to a surgical mask is used. While these are preferred embodiments, the invention is not so limited and other types of masks are also within the scope of the invention.

Preferably, the mask includes fastening devices, such that they can be worn over the user's nose and mouth without the user holding the mask in place. These fastening devices can be varied in type and include: an elastic material, attached to at least two points on the mask that circumscribes the user's head; materials suitable for tying attached to at least two points on the mask that are then tied together behind the user's head; and two pieces of material, preferably elastic, each in the shape of a loop, attached to the left and right sides of the mask respectively and suitable for placing behind the user's ears. This list is meant to be illustrative of the possible fastening devices that can be used. However, it should not be construed as limiting the invention to only these fasteners.

In each of the described embodiments of the invention, the respirator comprises a number of layers that are substrates for one or more germicidal or virucidal composition and that inhibit or prevent the passage of pathogens to the user. Additionally, passive bacterial and viral filtration can be achieved via one or more tightly woven or nonwoven layers.

Suitable layers or substrates for the virucidal compositions include woven materials, such as tightly woven microfibril cloth; tightly woven cotton cloth; absorbent cellulose fiber layers; woven fabrics; textiles; and non-wovens such as polymer-laid fabrics, including spunbonded and meltblown materials, dry-laid and wet-laid non-wovens, etc.

The present invention provides for the use of various concentrations of two or more water soluble zinc salts alone or with other anti-pathogenic agents, in coatings applied to articles that come in contact with the skin. Such articles include, but are not limited to, barrier articles such as gloves, masks, as well as articles such as eye protection devices, medical drapes, protective clothing, footwear, wound dressings, devices applied to stoma (e.g., colostomy bags, tracheostomy tubes and fittings), surgical masks, etc. Examples of non-medical articles that may be coated according to the invention include, but are not limited to, gloves or rubber fingers used in the food service industry, banking industry, or gardening, athletic wear including supports and gloves, etc.

When discussing coatings according to the invention, percentages are in weight percent unless indicated otherwise. Further, such percentages refer to a coating solution used to coat the article, rather than the amount present after the coating solution has dried, unless indicated otherwise.

Water soluble zinc salts exhibit a molar solubility in water of at least 0.1 moles/liter and preferably at least 0.17 moles/liter, at 25° C. Water soluble zinc salts for use in these formulations include zinc acetate (molar solubility in water of 1.64 moles/l at 25° C.), zinc butyrate (molar solubility in water of 0.4 moles/l), zinc gluconate (molar solubility in water of 0.28 moles/l), zinc glycerate (moderately water soluble), zinc glycolate (moderately water soluble), zinc formate (molar solubility in water of 0.33 moles/l at 20° C.), zinc lactate (molar solubility in water of 0.17 moles/l), zinc picolinate (moderately water soluble), zinc propionate (molar solubility in water of 1.51 moles/l), zinc salicylate (low water solubility), zinc tartrate (moderately water soluble) and zinc undecylenate (moderately water soluble). In preferred non-limiting embodiments, the present invention provides for formulations for coating of articles comprising two or more water soluble zinc salts each having a molar solubility in water of about 0.01-1.64 moles/liter, wherein the total weight percent of all water soluble zinc salts is between about 0.0001 and 99.9999 percent.

Zinc pyrithione has a lower solubility in water but is sufficient for purposes of the present invention as organic solvents can be added. Zinc pyrithione has a solubility in water of 15 mg/kg; at pH=8 35 mg/kg; in ethanol 100 mg/kg; and in polyethylene glycol (PEG400) 2000 mg/kg.

A water insoluble zinc salt, as that term is used herein, refers to a compound having a water solubility of less than 0.1 moles/liter at 25° C. Non-limiting examples of water insoluble zinc salts include zinc oxide, zinc stearate, zinc citrate, zinc phosphate, zinc carbonate, and zinc borate. In specific, non-limiting embodiments, the water insoluble zinc salt is solubilized by means of organic solvents.

The formulations of the invention may be applied as coatings, in an article having more than one surface, so as to coat at least one surface (the entire surface or a portion thereof) of the article. As specific, non-limiting embodiments, a coating according to the invention may be applied to the middle surface of a three layer mask, or to the outer surface, or to both inner and outer surfaces. Different coatings may be applied to each surface.

In a first embodiment of the invention there is provided a composition for imparting anti-pathogenic properties to a breathable substrate material comprising: (a) 0.0001-99.9999% by weight of a compound of the formula I

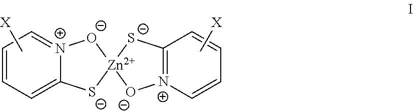

where X is a substituent at any carbon in the pyridine ring selected from the group consisting of H, C₁-C₅ alkyl, C₁-C₅ alkoxy, F, Cl, Br and I; and

(b) 0.0001-99.9999% by weight of an additional zinc salt selected from the group consisting of zinc acetate, zinc propionate, zinc oxalate, zinc benzoate, zinc gluconate, zinc ascorbate, zinc lactate, zinc glycolate, zinc citrate, zinc glycinate, zinc maleate, zinc glycinate, zinc fumarate, zinc salts of omega fatty acids, zinc polyacrylate, zinc polylactate, zinc polyglycolate and zinc polymaleate.

A preferred compound of formula I is one where X is hydrogen and having the formula

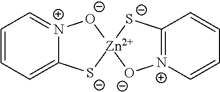

having a chemical name of bis(2-pyridylthio)zinc 1,1′-dioxide (Zinc pyrithione). Zinc pyrithione (or pyrithione zinc) is a coordination complex of zinc. It has fungistatic (that is, it inhibits the division of fungal cells), bacteriostatic (inhibits bacterial cell division) properties and anti-viral properties.

The invention also provides compositions for imparting anti-viral properties to a breathable substrate material comprising effective amounts of two or more zinc salts selected from the group consisting of zinc acetate, zinc propionate, zinc oxalate, zinc benzoate, zinc gluconate, zinc ascorbate, zinc citrate, zinc maleate, zinc fumarate, zinc picolinate, zinc propionate, zinc glycinate, zinc salicylate, zinc tartrate, zinc lactate, zinc glycolate, zinc undecylenate, zinc salts of omega fatty acids, zinc polyacrylate, zinc polylactate, zinc polyglycolate and zinc polymaleate.

The compositions of the invention are preferably prepared in liquid form by adding a solvent such as water, ethanol, acetone, isopropanol or propanol or mixtures thereof. The compositions in Table 1 below are preferred for imparting anti-pathogenic properties to the substrates.

Primers may be incorporated into the nonwovens prior to coating with the zinc compositions of the invention. Typical primers include polyvinyl alcohol, nonionic surfactants, acrylic resins, rosin esters, and mixtures thereof. A typical primer composition contains 10 wt % to 30 wt % a polyvinyl alcohol having a weight average molecular weight from about 50,000 Mw to about 250,000 Mw; a nonionic surfactant present in an amount of 15 wt % to 70 wt %; and water. The primer composition may also include polyethylene glycols of MW 400 to MW 6000.

Typical nonionics that are useful in the present invention includes Cetearyl Alcohol Ethoxylate 5-25 EO, Cetyl Alcohol Ethoxylate 2-20 EO, Cetyl Oleyl Alcohol Ethoxylate 2-30 EO, Lauryl Alcohol Ethoxylate 1-23 EO, Stearyl Alcohol Ethoxylate 2-20 EO, Isodecyl Alcohol Ethoxylate 3-8 EO, Isotridecyl Alcohol Ethoxylate 3-15 EO, C₉₋₁₁ Alcohol Ethoxylate 2.5-8 EO, Tallow Fatty Amine Ethoxylate 2-20 EO, Coconut Fatty Amine Ethoxylate 2-5 EO, Ditallow Amine Ethoxylate 15 EO, Castor Oil Ethoxylate 5-54 EO, Hydrogenated Castor Oil Ethoxylate 25-40 EO, Lauryl Alcohol Ethoxylated and Propoxylated, Ethoxylated Sorbitan Monolaurate 20-80 EO, Polyethylene Glycol 200-8000 MW, Glycerine Ethoxylate 26 EO, Nonylphenol Ethoxylate 4-100 EO and copolymers of ethylene oxide and propylene oxide.

Preferred primer compositions contains 10 wt % by weight a polyvinyl alcohol having a weight average molecular weight from about 50,000 Mw to about 250,000 Mw; 15% by weight of a nonionic surfactant selected from the group consisting of Cetearyl Alcohol Ethoxylate 5-25 EO, Cetyl Alcohol Ethoxylate 2-20 EO, Cetyl Oleyl Alcohol Ethoxylate 2-30 EO, Lauryl Alcohol Ethoxylate 1-23 EO, Stearyl Alcohol Ethoxylate 2-20 EO, Isodecyl Alcohol Ethoxylate 3-8 EO, Isotridecyl Alcohol Ethoxylate 3-15 EO, C₉₋₁₁ Alcohol Ethoxylate 2.5-8 EO, Tallow Fatty Amine Ethoxylate 2-20 EO, Coconut Fatty Amine Ethoxylate 2-5 EO, Ditallow Amine Ethoxylate 15 EO, Castor Oil Ethoxylate 5-54 EO, Hydrogenated Castor Oil Ethoxylate 25-40 EO, Lauryl Alcohol Ethoxylated and Propoxylated, Ethoxylated Sorbitan Monolaurate 20-80 EO, Polyethylene Glycol 200-8000 MW, Glycerine Ethoxylate 26 EO, Nonylphenol Ethoxylate 4-100 EO and copolymers of ethylene oxide and propylene oxide.

The compositions may also include in addition to the solvents additives that enhance solubility such as surfactants, preservatives and other agents that enhance antiviral activity such as p-menthane-3,8-diol (PMD). When necessary the compositions may also include viscosity modifiers as required.

TABLE 1
Representative compositions of the invention.

| INGREDIENT 1 (Grams) | INGREDIENT 2 (Grams) | SOLVENT(S) |
|---|---|---|
| Zinc pyrithione - 0.01 gram | Zinc Acetate - 1 gram | H₂O - 100 ml |
| Zinc pyrithione - 0.05 gram | Zinc Acetate - 1 gram | H₂O - 100 ml |
| Zinc pyrithione - 0.05 gram | Zinc Acetate - 0.5 gram | H₂O - 100 ml |
| Zinc pyrithione - 0.01 gram | Zinc Ascorbate - 1 gram | H₂O - 50 ml - Ethanol - 50 ml |
| Zinc pyrithione - 0.05 gram | Zinc Ascorbate - 1 gram | H₂O - 50 ml - Ethanol - 50 ml |
| Zinc pyrithione - 0.001 gram | Zinc Ascorbate - 1 gram | H₂O - 50 ml - Ethanol - 50 ml |
| Zinc pyrithione - 0.01 gram | Zinc Acetate - 0.5 gram | H₂O - 50 ml - Ethanol - 50 ml |
| Zinc pyrithione - 0.05 gram | Zinc Acetate - 5 grams | H₂O - 50 ml - Ethanol - 50 ml |
| Zinc pyrithione - 0.001 gram | Zinc Gluconate - 2 grams | H₂O - 50 ml - Ethanol - 50 ml |
| Zinc pyrithione - 0.005 gram | Zinc Gluconate - 3.5 grams | H₂O - 50 ml - Ethanol - 50 ml |
| Zinc pyrithione - 0.005 gram | Zinc Gluconate - 3.5 grams | H₂O - 50 ml - Isopropanol - 50 ml |
| Zinc acetate - 5.0 grams | Zinc Gluconate - 3.5 grams | H₂O - 50 ml - Ethanol - 50 ml |
| Zinc acetate - 5.0 grams | Zinc Gluconate - 5.0 grams | H₂O - 50 ml - Ethanol - 50 ml |
| Zinc acetate - 5.0 grams | Zinc Ascorbate - 5.0 grams | H₂O - 50 ml - Ethanol - 50 ml |
| Zinc Ascorbate - 5.0 grams | Zinc Gluconate - 5.0 grams | H₂O - 50 ml - Ethanol - 50 ml |

The zinc compositions of the invention are applied to a polypropylene-based fabric or polypropylene-based material by any suitable method as will be understood by those with skill in the art with reference to this disclosure, such as for example by dipping the polypropylene-based fabric or polypropylene-based material into the composition, or by spraying or rolling the composition onto the polypropylene-based fabric or polypropylene-based material, and then drying the polypropylene-based fabric or polypropylene-based material. In one embodiment, drying comprises allowing the composition coated polypropylene-based fabric or composition coated polypropylene-based material to air dry at room temperature. In another embodiment, drying comprises using forced air or heat, such as for example by contacting the composition coated polypropylene-based fabric or composition coated polypropylene-based material with a heated roller in a production line.

As will be understood by those with skill in the art with reference to this disclosure, coating a polypropylene-based fabric or polypropylene-based material with the zinc compositions can be accomplished using a continuous production process where rolls of polypropylene-based fabric or polypropylene-based material are coated with the composition and dried, and then the coated polypropylene-based fabric or polypropylene-based material can be fed directly into fabrication machinery for producing a final structure, such as for example a protective face mask, or can be stored for later use.

As will be understood by those with skill in the art with reference to this disclosure, the composition can be used on any polypropylene-based fabric or polypropylene-based material, such as for example a polypropylene-based fabric or polypropylene-based material incorporated into a protective face mask. In one embodiment, there is provided a zinc composition coated polypropylene-based material having alternating spunbond non-woven polypropylene fiber (S) and melt blown polypropylene fiber (M) layers, such as for example MS, SM, SMS, SSMS, SMSS, SMSMS, SMMSS and SSMMS. In one embodiment, the polypropylene-based material having alternating spunbond non-woven polypropylene fiber (S) and melt blown polypropylene fiber (M) layers further comprises one or more than one layer that decreases the transmission of the human pathogen by antibacterial, antifungal and antiviral activity, such as for example, a layer of fabric according to the present invention that decreases the transmission of the human pathogen by antibacterial, antifungal and antiviral activity. In one embodiment, the polypropylene-based material having the alternating layers is incorporated into a protective face mask.

There is an ongoing need to improve filtering non-woven fabrics, particularly in view of perception of risks from coronaviruses particularly Cov-1 and Cov-2. The present inventors have identified filter materials, which may facilitate an increased level of removal of harmful virus and/or other micro-organisms from inhaled air and neutralization of the same, enabling the use of such materials in an improved nasal and/or mouth filter.

According to one aspect of this invention there is provided an air-permeable substrates useful for making masks of a shape suitable to be placed over a user's mouth and nose and to sealingly contact the user's face, provided with means to hold the mask in place on the user's face, and comprising one or more layer of a filter material positioned such that inhaled and/or exhaled air of the user passes through the filter material, wherein the filter material comprises an air permeable substrate coated with anti-viral agents.

The overall shape of the face mask may be generally conventional in the field of face masks, and the means to hold the mask in place on the user's face may for example comprise one or more elastic strap to be passed behind the user's head.

Suitable substrates for use in conjunction with the anti-pathogenic formulation described herein include substrates, including but not limited to, paper, paper laminates, non-woven materials, non-woven laminates, and other similar substrates. The invention is primarily concerned with substrates targeted for use in medical-type applications, such as surgical gowns and drapes, examining table paper, hospital bed pads, hospital bed inserts and sheeting, surgical masks and other hospital or medical-type applications which will be readily apparent to the skilled artisan after reading and understanding the technology disclosed herein. The term “medical” as used herein further includes the use of the described and similar items in dental and other medically related environments, i.e. tray liners and instrument wraps, masks, dental patient bibs, etc.

While the primary use of the invention is in the medical-type environment, it is also envisioned that the coated substrates described will find application in personal hygiene type uses, such as toilet seat covers. This type of item includes not only publicly provided items, but also personal items, which can be carried by an individual for private use.

### Paper Substrates

One potential substrate is paper, which once coated may be used, for instance, as examining table roll or cover where there is a high risk of exposure to bacteria and other viral pathogens. Other uses for coated paper products include tray liner paper for surgical or medical instrument trays, wrapping for sterilized surgical or medical instruments, medical packaging paper, and other uses.

For the foregoing and other similar applications, appropriate paper substrates include medium weight papers which are not too flimsy, and therefore do not easily tear or shred, but which are also not too heavy. The paper must be able to withstand winding tensions on a web coating machine or apparatus without suffering performance degradation. Further, papers suitable for this application should exhibit good hold out, which is closely related to the porosity of the substrate and is exhibited by the capability of the paper to maintain the coating without penetration or bleed through. Other characteristics which will affect the suitability of a paper substrate for use in this invention include the tensile strength of the paper, the stiffness of the paper, drapeability, alcohol and water repellency, bursting strength, air permeability, flammability, and abrasion and tear resistance. It is intended that these paper substrates, once coated, act as a barrier to bacteria and viruses in the dry state, and become activated, releasing the anti-pathogenic component, to eliminate bacteria and viruses when wet.

Specific examples of suitable paper substrates include standard paper substrates made from wood pulp and processed with cellulosic fibers. For example, suitable grade paper for the intended processing and uses may be selected from papers ranging between 17.5 lb to 20 lb per 3000 ft², available currently from James River Corporation under the Flexpac tradename, specifically BL FLEXPAC 20, and even a 13 lb per 3000 ft² grade paper available commercially from Coastal Paper Company by the designation BL MG PR HWS. The preferred grade of paper, then, is probably in a range between about 10 lb per 3000 ft² to about 30 lb per 3000 ft², with the selection within this range being dependent upon the intended use, i.e., the lighter weights may be suitable examining table paper while the heavier weights would be better suited to paper gowns. This range, however, may be extended beyond the stated limits as long as the paper substrate can meet the criteria stated above for processing and use, mechanically as well as with respect to release of the anti-pathogenic agent.

Coated papers and synthetic papers may also be suitable for use herein. For example, acceptable coated papers may be a cellulose based paper coated with an acrylic coating, such as Kimberly Clark's currently available 22.5 lb per 3000 ft² S-60857 product.

### Paper/Film Laminates

Paper/film laminate substrates in which the paper substrate is generally laminated to a polymeric film are also suitable paper substrates. They find particular application to the uses specified above with respect to paper substrates, but are further suitable in other applications where durability and low porosity are important considerations. The film component of a paper/film laminate is usually a material such as polyethylene, polypropylene or polyurethane, which enhances the hold-out of the substrate preventing the coating from penetrating through the composite.

With respect to the foregoing paper and paper laminate substrates, it should also be understood that a further consideration in selecting a substrate is whether the product is intended to be disposable or non-disposable, and if disposable, the likely manner in which the product will be disposed. For instance, consideration may be given to whether the product will be discarded with other medically related disposable items, or discarded with other non-medically related items in normal disposal situations, or whether there is a possibility of disposal by flushing, as in the case of toilet seat covers.

For items which will be disposed of in medical and/or non-medical refuse situations, biodegradability is desirable. Flushable items must exhibit poor wet strength, and yet have good hold out. Suitable flushable paper substrates include those available from Coastal Paper, which are light-weight bleached coating base tissues. Non-flushable paper substrates include Coastal Papers' for which the wet strength is too high, and paper laminates from Jen-Coat identified as Jen-Coat 19 #Semi Crepe/5 #LDPE Matte laminate (low density polyethylene).

In all instances, the paper substrates described hereinabove, including paper laminates, should be selected according to the ability of the paper to retain the coating to a degree sufficient to ensure elimination of bacterial or viral contamination. The product functions as a barrier to the virus and bacteria when dry, and actively eliminates or kills the virus or bacteria on contact when wet. Coated paper substrates with these qualities are suitable for use in a multitude of medically related and personal hygiene applications as described hereinabove.

### Non-Woven and Non-Woven Laminate Substrates

Non-woven substrates include such substrates as spun bonded fabrics and two-phase fabrics. Spun bonded fabrics are those formed from continuous filaments that have been extruded, drawn, laid on a continuous belt in a three-dimensional arrangement, and immediately thermally bonded to form a “web” of material. The extruded filaments have a thickness on the order of about 20 μm.

Another type of non-woven material available is a fabric called spunlaced fabric. This fabric is a three-dimensional structure resulting from the hydroentanglement of staple or base fibers without any chemical or thermal bonding, thus providing a material demonstrating excellent flexibility, softness and drape. The fabric may be composed of a single type of fiber, or may be a blend of fibers, with varying content ranges. For example, the fabric may be a rayon/polyester blend, a wood pulp/polyester blend or 100% polyester fiber. Fabric content is highly determinative of suitability for a specified purpose, i.e., durability, strength, absorbency and other properties are directly affected by fabric content.

SONTARA™, a DuPont product, is a spunlaced product available in a wide range of weights and in varying fiber contents. Of particular interest herein are those fabrics of a wood pulp/polyester blend, which adapt well to use in hospital gowns and drapes, and those of a rayon-polyester blend which perform well as absorbent wipes and sponges, and when pre-treated, as repellent barrier materials having high comfort qualities.

While non-woven substrates offer many advantages, they also represent special coating considerations. Often, non-woven substrates have been treated to enhance water and even alcohol repellency. Thus, many of these fabrics are attractive as operating room fabrics. These fabrics, however, are more likely than other substrates to experience coating absorption and penetration. To protect against these potential problems, which may occur with traditional web coating techniques, spray or dip coating methods have been found herein to provide suitable alternatives. When using these methods the subject formulation is modified, generally to achieve a thinner formula with lower solids content.

Non-woven laminates are those materials such as the non-woven substrates described above which have a laminate layer or a laminate backing to aid in solving potential absorption and penetration problems. In these fabrics, the non-woven material substrate is generally laminated to a film such as polyethylene, polypropylene or polyurethane. The film enhances the hold-out of the substrate, preventing the coating from penetrating through the non-woven composite.

Alternatively, the non-woven laminate may be a combination of non-woven fabric with a microporous film laminated thereto. This microporous film is generally a breathable film, which means that the film allows air to penetrate, but prevents the penetration of liquids. The moisture vapor transmission rate (MVTR) is a measure of the amount of moisture vapor that passes through a fabric. Fabrics with high MVTR, therefore, are cooler for the person wearing the garment than a lower MVTR fabric. Also, water vapor is smaller than droplets of blood and is, therefore, more readily passed through the micropores of the non-woven substrate. The practical result of the forgoing is that though moisture is transported through the fabric's micropores to keep the wearer of a high MVTR fabric gown comfortable, there is little danger of blood droplets, which may carry any number of pathogens, penetrating the gown or fabric and reaching the wearer. Specific examples of non-woven laminates include the following substrates marketed by Polybond, Inc.: Poly-Breathe I spunbonded polypropylene non-woven/polyethylene microporous film; Poly-Breathe II spunbonded polypropylene/heavy duty microporous film; and Poly Breathe Soft spunbonded polyethylene/microporous film having excellent drapeability.

Usually, the micro-porous film side of the laminate is most easily coated with the formulation which is the subject hereof because of superior hold-out which better lends itself to traditional web coating techniques. However, the non-woven fabric side of the laminate may be coated by alternate coating techniques if it is desirable for functional purposes. Other suitable non-woven fabric laminations include Bertek's Medifilm 432, which is a laminate of polyurethane film direct extrusion laminated onto SONTARA 8001 polyester fabric. Further, the non-woven may be a wood pulp/polyester blend such as SONTARA 8818 or 8801. The wood pulp/polyester blends are especially engineered as fabrics for medical applications due to their softness and high absorbency. The substrates also can be treated to repel liquids. The laminations cited above find particular applicability in medical garment and in wound care fabrics or products.

In those applications where the coating is provided in a multilayered design, the various coating layers may be provided on the same or on varying substrate materials. Further, in those instances where several substrates are coated with various layers of the coating formulation, the substrates may be placed into a single finished product construction. For example, this construction may be well suited to face masks.

The foregoing substrates are exemplary only. Any number of other substrates will be known to the skilled artisan, and are intended to be covered by the teachings herein, as long as the substrate maintains its integrity through the coating process, accepts the coating formulation and supports it in a manner whereby the anti-viral, anti-bacterial activity of the coating is not adversely affected to a point where it is no longer suitable as an anti-pathogenic coating, and the coated substrate is suitable for adaptation or application to use in the medical or personal hygiene fields.

The air-permeable substrate may comprise a fibrous substrate, which can either be a woven or non-woven material. Examples of woven materials include those natural and synthetic fibers such as cotton, cellulose, wool, polyolefins, polyester, polyamide (e.g. nylon), rayon, polyacrylonitrile, cellulose acetate, polystyrene, polyvinyls and any other synthetic polymers that can be processed into fibers. Examples of non-woven materials include polypropylene, polyethylene, polyester, nylon, PET and PLA. For this invention, non-woven is preferred. Such a material may be in the form of a non-woven sheet or pad.

Non woven polyester could be used as an air-permeable substrate. Polyester fibers and fabrics made therefrom are well known. The term “polyester” as used herein is a generic name for a manufactured fiber being a polymer with units linked by ester groups. A common polyester used for woven and non-woven fiber manufacture is polyethylene terephthalate, comprising:

—[—OCO—C6H4-COO—CH2-CH2-]n-

units.

The grade of fibrous substrate which may be used may be determined by practice to achieve a suitable through-flow of air, and the density may be as known from the face-mask art to provide a mask of a comfortable weight.

Another preferred material is non-woven polypropylene of the type conventionally used for surgical masks and the like which is widely available in sheet form. Suitable grades of non-woven polypropylene include the well known grades commonly used for surgical face masks and the like. Typical non-woven polypropylene materials found suitable for use in this invention have weights 10-40 g/m², although other suitable material weights can be determined empirically.

Typical non-woven polyester materials found suitable for use in this invention have weights 10-200 g/m², although materials toward the upper end of this range may be rather heavy for use in a face mask. For example materials of weight 20-100 g/m² are preferred, e.g. ca. 60 g/m². Such materials are commercially available. Other suitable materials can be determined empirically.

It has been found that the compositions of the invention having organic zinc salts and polymeric zinc salts are effective at capturing and neutralizing coronaviruses Cov-1 and Cov-2 in air passing through such a material. Without being limited to a specific theory of action it is believed that upon contact with the surface of the substrate the virus interact with the zinc agents, are entrapped and the localized environment of the zinc agent inactivates the virus to thereby neutralize them. It is believed that the filter material of this invention may be effective in this manner against the viruses that cause colds, influenza, SARS (both Cov-1 and Cov-2), RSV, bird flu and mutated serotypes of these.

Additional substances may be incorporated into the filter material, for example additional substances to optimize the properties and anti-viral effectiveness of the filter material.

The filter material may also incorporate one or more surfactant. A surfactant can facilitate wetting of the filter material. Airborne pathogens such as viruses are known to be carried in small droplets of water, and consequently enhanced wetting of the filter material can enhance the effective contact between the pathogen and the active materials on the filter material. Furthermore surfactants are known to be effective in disrupting the membranes of virus and bacteria. Non-ionic surfactants are preferred. A preferred non-ionic surfactant is selected from the Tween™ or Polysorbate™ or Triton X™ family of surfactants.

Suitable coating techniques for use with the subject invention include spray, dip coating and inkjet printing techniques.

Spray coating is highly suited to use for more porous substrates because it affords greater control over penetration of the coating into the substrate. With spray coating the coating formulation is essentially atomized into a fine mist so that it can be applied to the porous substrate without excess penetration to the opposite side of the substrate, assuming heavy coat weights are not applied. However, the spray coating could also be applied to both sides of the web, if desirable. In order to atomize the coating formulation, it should be thinned. Proper atomization of the coating is important to the even and uniform application of the coating, as are the amount and pressure of air flow. Disadvantages of the spray coating technique are that atomization generally requires a formulation having lower solids, therefore wasted solvent and over spraying may be problems. Further, it can sometimes be difficult to control coat weight uniformity when using the spray coating technique.

Dip coating is another viable alternative coating method. Dip coating is probably the simplest form of coating in terms of equipment, however uniformity of coating requires that great care be taken to control the rate of withdrawal of the substrate from the coating, solvent evaporation, drainage, etc. In this technique, the substrate is passed from a lead-in roll to an immersion roll placed in or over a coating pan. The immersion roll is positioned high or low depending on the desire to coat only one or both sides of the non-woven web. This method, like spray coating, requires low solids content of the coating formulation and is significantly affected by the porosity of the substrate, as well as by environmental and mechanical parameters. In dip coating, the entire non-woven substrate is immersed in the coating and the substrate is impregnated. Because a lower solids formulation is typically required, environmental concerns due mostly to solvent evaporation must be addressed.

For spray and dip coating, the standard formulation is typically diluted to generally 1-20% solids, preferably 5% solids, as compared to a 25%-35% solids range usable with roll coating methods and techniques. In addition, the coating formulation can be modified in other manners regarding component content levels to achieve coatable solutions for a given technique.

To achieve a suitable amount of inactivation of pathogens such as viruses in air passing through the face mask, combined with permeability of a suitable rate of inhaled or exhaled air, the total loading of the zinc compositions of the invention on the substrate of the filter material is preferably in the range 0.1-50 g/m², particularly 1.5-45 g/m². For substrates of the typical weights per square meter discussed herein this can correspond to total loading of the zinc composition on the substrate of the filter material, (based on the substrate itself of a starting 100% weight) of 5-50 wt %, typically 10-30 wt %.

The filter material may also incorporate one or more anti-microbial compounds. Suitable examples of such compounds include quaternary ammonium compounds (e.g. benzalkonium chloride, cetrimide), phenolic compounds (e.g. triclosan, benzoic acid), biguanides (e.g. chlorhexidine, alexidine) and mixtures thereof.

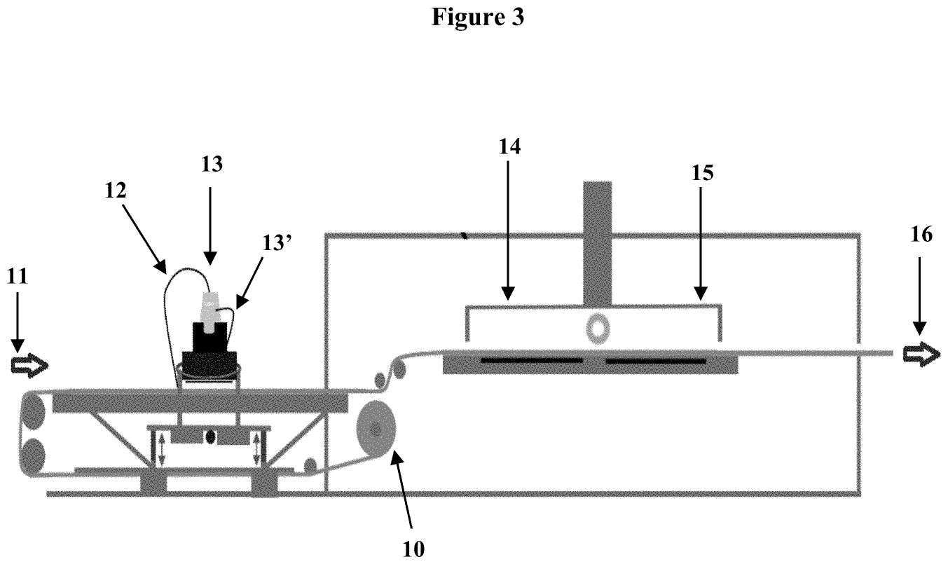

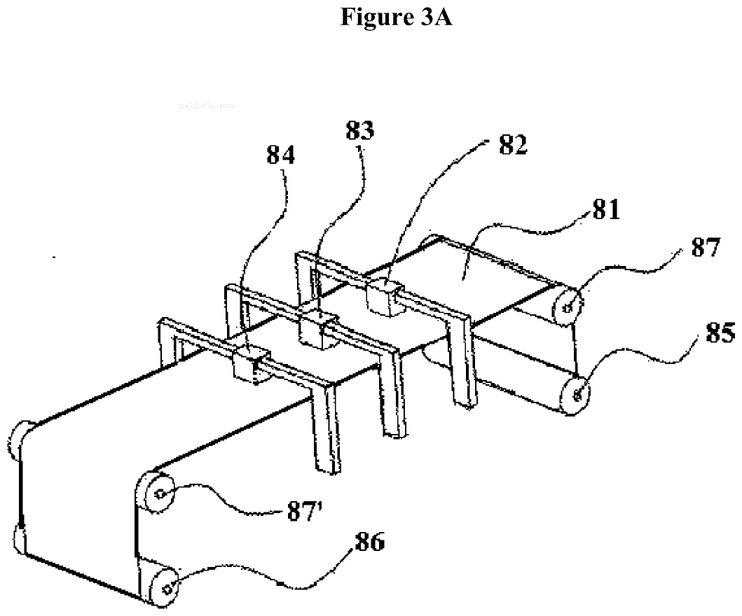

The invention also provides a method of coating or printing anti-pathogenic substances on a non-woven fabric to impart anti-pathogenic properties by using an inkjet printer, the method comprising: feeding a fabric by a fabric feed roller; selecting, through a control unit, at least one pretreatment liquid component to be applied from a plurality of pretreatment primer liquid components installed in a pretreatment liquid reservoir, depending upon a type of the fed fabric, and determining, through the control unit, an application ratio of the selected at least one pretreatment liquid component; controlling, by the control unit, a pretreatment head such that the selected at least one pretreatment primer liquid component is mixed based on the determined application ratio and is applied to the fed fabric, wherein an application amount of the selected at least one pretreatment primer liquid component or a frequency at which the selected at least one pretreatment primer liquid component applied to the fabric is adjusted depending upon the type of the fed fabric; drying the selected at least one pretreatment primer liquid applied to the fabric through a dryer; and coating or printing on the dried fabric by jetting an anti-pathogenic ink installed in an ink reservoir through a printing head. As shown in FIG. 3, it illustrates coating the non-woven fabric using inkjet technology. A non-woven fabric roll 10 is unwinded and conveyed to entry point 11 and then further moved into the coating area having an inkjet printing head 12 and coating anti-viral solution 13 to provide an inkjet coating stream 13′ and the passing the coated fabric through drying tunnel 14 and convection removal location 15 and then passing the coated fabric through exit point 16 into a winding roller (not shown). The fabric may also be pretreated with primer, which is also applied with inkjet technology.

The present invention is also applicable to High-efficiency particulate air (HEPA) filters, also known as high-efficiency particulate absorbing and high-efficiency particulate arrestance, which is an efficiency standard of air filter.

The HEPA filters can be sprayed with the compositions of the invention to provide them with anti-pathogenic properties in the event that contaminated air with pathogens is circulating in residential buildings, homes, industrial buildings, cruise ships and airplanes.

The HEPA filters of the invention are used in applications that require contamination control, such as the manufacturing of disk drives, medical devices, semiconductors, nuclear, food and pharmaceutical products, as well as in hospitals, homes, cruise ships, airplanes and vehicles.

The nonwoven fabrics and filters of the invention have excellent antiviral properties and provide excellent protection in environments where highly contagious viruses are present.

The invention also provides multilayer (as many as 6 layers) masks where each fabric layer has anti-pathogenic coatings in increasing or decreasing concentration across the layers of fabrics or concentrations in other fashion i.e., the middle layer has higher concentration that outer layer or the inner layer closer to the skin. A suitable layered construction utilizing the fabrics of the invention has an outer layer having 10-15% by weight of the antiviral compositions of the invention containing mixtures of zinc compounds, then an inner fabric material containing the zinc compositions of the invention, such as a non-woven polypropylene material which in use is against the user's skin containing 1-5% by weight of the compositions of the invention, and an optional outer layer also of a non-woven polypropylene material also containing 5-10% by weight of the compositions of the invention. There may be plural layers all containing the zinc compositions of the invention. The three layers contain the zinc compositions of the invention either in decreasing amounts from front to back, or vices versa and also the middle layer having the highest concentration by weight of the zinc compositions of the invention.

### EXAMPLES

The following examples are intended to demonstrate the usefulness of preferred embodiments of the present invention and should not be considered to limit its scope or applicability in any way.

The compositions of the examples below are prepared by weighing the amount of zinc salts as required, then placing the salts in a glass lined steel vessel equipped with a stirrer and then adding the amount of solvent needed as shown in each of the examples. Stirring as required is done and when required to accelerate the dissolution the vessel may be heated.

### Example I

| Component | Amount | |
|---|---|---|
| Zinc pyrithione | 0.01 | gram |
| Zinc Acetate | 1 | gram |
| Water | 100 | ml |

### Example II

| Component | Amount | |
|---|---|---|
| Zinc pyrithione | 0.1 | gram |
| Zinc Acetate | 10 | gram |
| Water | 1000 | ml |

### Example III

| Component | Amount | |
|---|---|---|
| Zinc pyrithione | 1 | gram |
| Zinc Acetate | 100 | gram |
| Water | 10 | liters |

### Example IV

| Component | Amount | |
|---|---|---|
| Zinc pyrithione | 10 | grams |
| Zinc Acetate | 1000 | grams |
| Water | 100 | liters |

### Example V

| Component | Amount | |
|---|---|---|
| Zinc pyrithione | 0.05 | gram |
| Zinc Acetate | 1 | gram |
| Water | 100 | ml |

### Example VI

| Component | Amount | |
|---|---|---|
| Zinc pyrithione | 0.5 | gram |
| Zinc Acetate | 10 | grams |
| Water | 1000 | ml |

### Example VII

| Component | Amount | |
|---|---|---|
| Zinc pyrithione | 5 | grams |
| Zinc Acetate | 100 | grams |
| Water | 10 | liters |

### Example VIII

| Component | Amount | |
|---|---|---|
| Zinc pyrithione | 50 | grams |
| Zinc Acetate | 1000 | grams |
| Water | 100 | liters |

### Example IX

| Component | Amount | |
|---|---|---|
| Zinc pyrithione | 0.05 | gram |
| Zinc Acetate | 0.5 | gram |
| Water | 100 | ml |

### Example X

| Component | Amount | |
|---|---|---|
| Zinc pyrithione | 0.5 | gram |
| Zinc Acetate | 5 | gram |
| Water | 1000 | ml |

### Example XI

| Component | Amount | |
|---|---|---|
| Zinc pyrithione | 5 | grams |
| Zinc Acetate | 50 | grams |
| Water | 10 | Liters |

### Example XII

| Component | Amount | |
|---|---|---|
| Zinc pyrithione | 50 | grams |
| Zinc Acetate | 500 | grams |
| Water | 100 | Liters |

### Example XIII

| Component | Amount | |
|---|---|---|
| Zinc pyrithione | 0.01 | gram |
| Zinc Ascorbate | 1 | gram |
| Water | 50 | ml |
| Ethanol | 50 | ml |

### Example XIV

| Component | Amount | |
|---|---|---|
| Zinc pyrithione | 0.1 | gram |
| Zinc Ascorbate | 10 | grams |
| Water | 500 | ml |
| Ethanol | 500 | ml |

### Example XV

| Component | Amount | |
|---|---|---|
| Zinc pyrithione | 1 | gram |
| Zinc Ascorbate | 100 | grams |
| Water | 5 | liters |
| Ethanol | 5 | liters |

### Example XVI

| Component | Amount | |
|---|---|---|
| Zinc pyrithione | 10 | grams |
| Zinc Ascorbate | 1000 | grams |
| Water | 50 | liters |
| Ethanol | 50 | liters |

### Example XVII

| Component | Amount | |
|---|---|---|
| Zinc pyrithione | 0.05 | gram |
| Zinc Ascorbate | 1 | gram |
| Water | 50 | ml |
| Ethanol | 50 | ml |

### Example XVIII

| Component | Amount | |
|---|---|---|
| Zinc pyrithione | 0.5 | gram |
| Zinc Ascorbate | 10 | grams |
| Water | 500 | ml |
| Ethanol | 500 | ml |

### Example XIX

| Component | Amount | |
|---|---|---|
| Zinc pyrithione | 5 | grams |
| Zinc Ascorbate | 100 | grams |
| Water | 5 | liters |
| Ethanol | 5 | liters |

### Example XX

| Component | Amount | |
|---|---|---|
| Zinc pyrithione | 50 | grams |
| Zinc Ascorbate | 1000 | grams |
| Water | 50 | liters |
| Ethanol | 50 | liters |

### Example XXI

| Component | Amount | |
|---|---|---|
| Zinc pyrithione | 0.001 | gram |
| Zinc Ascorbate | 1 | gram |
| Water | 50 | ml |
| Ethanol | 50 | ml |

### Example XXII

| Component | Amount | |
|---|---|---|
| Zinc pyrithione | 0.01 | gram |
| Zinc Ascorbate | 10 | grams |
| Water | 500 | ml |
| Ethanol | 500 | ml |

### Example XXIII

| Component | Amount | |
|---|---|---|
| Zinc pyrithione | 0.1 | gram |
| Zinc Ascorbate | 100 | grams |
| Water | 5 | Liters |
| Ethanol | 5 | Liters |

### Example XXIV

| Component | Amount | |
|---|---|---|
| Zinc pyrithione | 1 | gram |
| Zinc Ascorbate | 1000 | grams |
| Water | 50 | Liters |
| Ethanol | 50 | Liters |

### Example XXV

| Component | Amount | |
|---|---|---|
| Zinc pyrithione | 0.01 | gram |
| Zinc Acetate | 0.5 | gram |
| Water | 50 | ml |
| Ethanol | 50 | ml |

### Example XXVI

| Component | Amount | |
|---|---|---|
| Zinc pyrithione | 0.1 | gram |
| Zinc Acetate | 5 | grams |
| Water | 500 | ml |
| Ethanol | 500 | ml |

### Example XXVII

| Component | Amount | |
|---|---|---|
| Zinc pyrithione | 1 | gram |
| Zinc Acetate | 50 | grams |
| Water | 5 | liters |
| Ethanol | 5 | liters |

### Example XXVIII

| Component | Amount | |
|---|---|---|
| Zinc pyrithione | 10 | gram |
| Zinc Acetate | 500 | grams |
| Water | 50 | liters |
| Ethanol | 50 | liters |

### Example XXIX

| Component | Amount | |
|---|---|---|
| Zinc pyrithione | 0.05 | gram |
| Zinc Acetate | 5 | gram |
| Water | 50 | ml |
| Ethanol | 50 | ml |

### Example XXX

| Component | Amount | |
|---|---|---|
| Zinc pyrithione | 0.5 | gram |
| Zinc Acetate | 50 | gram |
| Water | 500 | ml |
| Ethanol | 500 | ml |

### Example XXXI

| Component | Amount | |
|---|---|---|
| Zinc pyrithione | 5 | grams |
| Zinc Acetate | 500 | grams |
| Water | 5 | liters |
| Ethanol | 5 | liters |

### Example XXXII

| Component | Amount | |
|---|---|---|
| Zinc pyrithione | 50 | grams |
| Zinc Acetate | 5000 | grams |
| Water | 50 | liters |
| Ethanol | 50 | liters |

### Example XXXIII

| Component | Amount | |
|---|---|---|
| Zinc pyrithione | 0.001 | gram |
| Zinc Gluconate | 2 | grams |
| Water | 50 | ml |
| Ethanol | 50 | ml |

### Example XXXIV

| Component | Amount | |
|---|---|---|
| Zinc pyrithione | 0.01 | gram |
| Zinc Gluconate | 20 | grams |
| Water | 500 | ml |
| Ethanol | 500 | ml |

### Example XXXV

| Component | Amount | |
|---|---|---|
| Zinc pyrithione | 0.1 | gram |
| Zinc Gluconate | 200 | grams |
| Water | 5 | liters |
| Ethanol | 5 | liters |

### Example XXXVI

| Component | Amount | |
|---|---|---|
| Zinc pyrithione | 1 | gram |
| Zinc Gluconate | 2000 | grams |
| Water | 50 | liters |
| Ethanol | 50 | liters |

### Example XXXVII

| Component | Amount | |
|---|---|---|
| Zinc pyrithione | 0.005 | gram |
| Zinc Gluconate | 3.5 | grams |
| Water | 50 | ml |
| Ethanol | 50 | ml |

### Example XXXVIII

| Component | Amount | |
|---|---|---|
| Zinc pyrithione | 0.05 | gram |
| Zinc Gluconate | 35 | grams |
| Water | 500 | ml |
| Ethanol | 500 | ml |

### Example XXXIX

| Component | Amount | |
|---|---|---|
| Zinc pyrithione | 0.5 | gram |
| Zinc Gluconate | 350 | grams |
| Water | 5 | liters |
| Ethanol | 5 | liters |

### Example XL

| Component | Amount | |
|---|---|---|
| Zinc pyrithione | 5 | gram |
| Zinc Gluconate | 3500 | grams |
| Water | 50 | liters |
| Ethanol | 50 | liters |

### Example XLI

| Component | Amount | |
|---|---|---|
| Zinc pyrithione | 0.005 | gram |
| Zinc Gluconate | 3.5 | grams |
| Water | 50 | ml |
| Isopropanol | 50 | ml |

### Example XLII

| Component | Amount | |
|---|---|---|
| Zinc pyrithione | 0.05 | gram |
| Zinc Gluconate | 35 | grams |
| Water | 500 | ml |
| Isopropanol | 500 | ml |

### Example XLIII

| Component | Amount | |
|---|---|---|
| Zinc pyrithione | 0.5 | gram |
| Zinc Gluconate | 350 | grams |
| Water | 5 | liters |
| Isopropanol | 5 | liters |

### Example XLIV

| Component | Amount | |
|---|---|---|
| Zinc pyrithione | 5 | gram |
| Zinc Gluconate | 3500 | grams |
| Water | 50 | liters |
| Isopropanol | 50 | liters |

### Example XLV

| Component | Amount | |
|---|---|---|
| Zinc pyrithione | 5 | grams |
| Zinc Acetate | 500 | grams |
| Water | 5 | liters |
| Ethanol | 5 | liters |

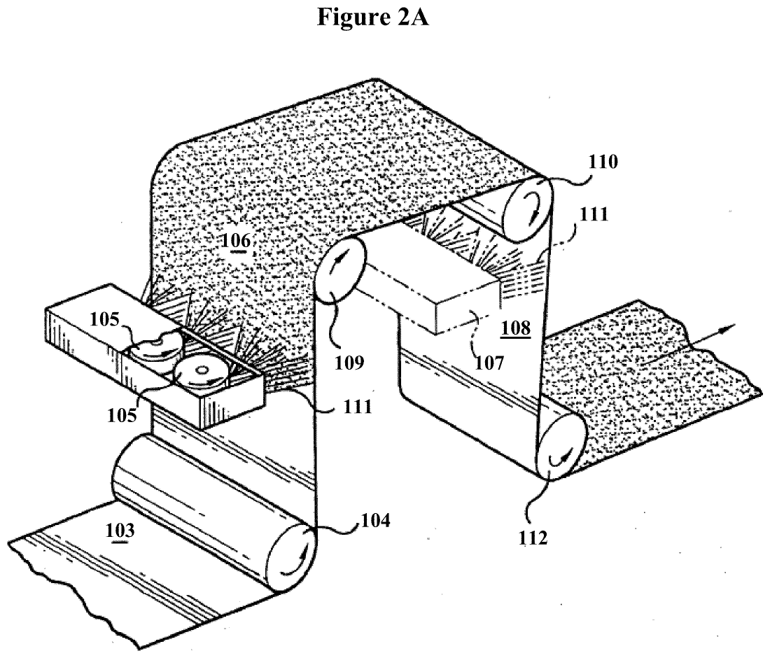

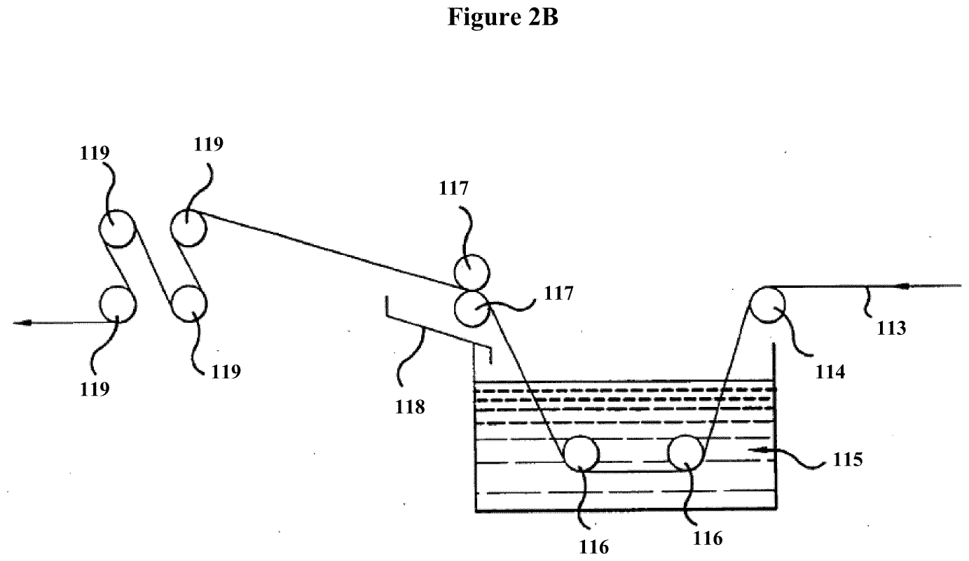

The above composition is placed in the dip coating vessel 6 as illustrated in FIG. 2. The fabric non-woven web was then passed through the dip primer coating vessel 5 and then through the dip coating vessel 6 at a speed of about 1 meter every 15 seconds. The speed may also be adjusted to feeding rate of 5 m/min. The speed is adjusted depending on the desired amount of zinc salts to be deposited on the surface. The primer is a composition containing 10 wt % by weight a polyvinyl alcohol having a weight average molecular weight from about 50,000 Mw; 15% by weight of Cetearyl Alcohol Ethoxylate EO 15 and the remainder water by weight.

### Example XLVI

| Component | Amount | |
|---|---|---|
| Zinc Acetate | 500 | grams |
| Water | 5 | liters |
| Ethanol | 5 | liters |

The above composition is placed in the dip coating vessel 6 as illustrated in FIG. 2. The fabric non-woven web was then passed through the dip primer coating vessel 5 and then through the dip coating vessel 6 at a speed of about 1 meter every 15 seconds. The primer is a composition containing 10 wt % by weight a polyvinyl alcohol having a weight average molecular weight from about 50,000 Mw; 15% by weight of Nonylphenol Ethoxylate 25 EO and the remainder water by weight.

### Example XLVII

| Component | Amount | |
|---|---|---|
| Zinc Acetate | 500 | grams |
| Zinc Ascorbate | 250 | grams |
| Water | 5 | liters |
| Ethanol | 5 | liters |

The above composition is placed in the dip coating vessel 6 as illustrated in FIG. 2. The fabric non-woven web was then passed through the dip primer coating vessel 5 and then through the dip coating vessel 6 at a speed of about 1 meter every 15 seconds. The primer is a composition containing 10 wt % by weight a polyvinyl alcohol having a weight average molecular weight from about 50,000 Mw; 15% by weight of Lauryl Alcohol Ethoxylate 15 EO and the remainder water by weight.

### Example XLVIII

| Component | Amount | |
|---|---|---|
| Zinc Acetate | 500 | grams |
| Zinc Gluconate | 250 | grams |
| Water | 5 | liters |
| Ethanol | 5 | liters |

The above composition is placed in the dip coating vessel 6 as illustrated in FIG. 2. The fabric non-woven web was then passed through the dip primer coating vessel 5 and then through the dip coating vessel 6 at a speed of about 1 meter every 15 seconds. The primer is a composition containing 10 wt % by weight a polyvinyl alcohol having a weight average molecular weight from about 50,000 Mw; 15% by weight of Nonylphenol Ethoxylate 20 EO and the remainder water by weight.

### Example XLIX

| Component | Amount | |
|---|---|---|
| Zinc Ascorbate | 500 | grams |
| Zinc Gluconate | 250 | grams |
| Water | 5 | liters |
| Ethanol | 5 | liters |

The above composition is placed in the dip coating vessel 6 as illustrated in FIG. 2. The fabric non-woven web was then passed through the dip primer coating vessel 5 and then through the dip coating vessel 6 at a speed of about 1 meter every 15 seconds. The primer is a composition containing 10 wt % by weight a polyvinyl alcohol having a weight average molecular weight from about 50,000 Mw; 15% by weight of Lauryl Alcohol Ethoxylate 10 EO and the remainder water by weight.

### Example L

| Component | Amount | |
|---|---|---|
| Zinc Acetate | 500 | grams |
| Zinc Polyacrylate | 250 | grams |
| Water | 5 | liters |
| Ethanol | 5 | liters |

The above composition is placed in the dip coating vessel 6 as illustrated in FIG. 2. The fabric non-woven web was then passed through the dip primer coating vessel 5 and then through the dip coating vessel 6 at a speed of about 1 meter every 15 seconds. The primer is a composition containing 10 wt % by weight a polyvinyl alcohol having a weight average molecular weight from about 50,000 Mw; 15% by weight of Cetyl Alcohol Ethoxylate 20 EO and the remainder water by weight.

### Example LI

| Component | Amount | |
|---|---|---|
| Zinc Acetate | 500 | grams |
| Zinc Polymaleate | 250 | grams |
| Water | 5 | liters |
| Ethanol | 5 | liters |

The above composition is placed in the dip coating vessel 6 as illustrated in FIG. 2. The fabric non-woven web was then passed through the dip primer coating vessel 5 and then through the dip coating vessel 6 at a speed of about 1 meter every 15 seconds. The primer is a composition containing 10 wt % by weight a polyvinyl alcohol having a weight average molecular weight from about 50,000 Mw; 15% by weight of Nonylphenol Ethoxylate 12 EO and the remainder water by weight.

### Example LII

| Component | Amount | |
|---|---|---|
| Zinc Acetate | 500 | grams |
| Zinc Gluconate | 50 | grams |
| Water | 5 | liters |
| Ethanol | 5 | liters |

The above composition is used using the inkjet printing arrangement as illustrated in FIG. 3.

### Example LIII

| Component | Amount | |
|---|---|---|
| Zinc Acetate | 500 | grams |
| Zinc Ascorbate | 50 | grams |
| Water | 5 | liters |
| Ethanol | 5 | liters |

The above composition is used using the inkjet printing arrangement as illustrated in FIG. 3.

### Example LIIIA

| Component | Amount | |
|---|---|---|
| Zinc Acetate | 500 | grams |
| p-menthane-3,8-diol (PMD) | 10 | grams |
| Water | 5 | liters |
| Ethanol | 5 | liters |

### Example LIIIB

| Component | Amount | |
|---|---|---|
| Zinc Acetate | 500 | grams |
| Zinc gluconate | 50 | grams |
| p-menthane-3,8-diol (PMD) | 10 | grams |
| Water | 5 | liters |
| Ethanol | 5 | liters |

In the coating of nonwoven fabric examples above, the fabrics are coated until 1% to 80% by weight of the zinc salts is absorbed onto the fabrics based on total weight of the fabric. The total amount of zinc salts absorbed is effected so it provides effective concentrations of the zinc salts to prevent virus infections and prevent virus replication.

The coating amount (the increased weight) may be adjusted to be in the range of 100 mg/m² to 10 g/m².

### Example LIV

### Manufacture of a Pretreatment Liquid

### 1) Manufacture of Pretreatment Mixed Liquid 1

Glycerin 5%, Carboxyl methyl cellulose 1.5%, Urea 5% Triton X-100 5% (brand name: manufactured by Union Carbide) Sodium bicarbonate 5%, Purified water the balance amount.

The above substances were put into a suitable container, and then it was sufficiently agitated by using an agitator. Then, the agitated mixed liquid was let to pass through a membrane filter (manufactured by WS, using cellulose acetate or nitrocellulose as a membrane material). Thereby, a pretreatment liquid for the zinc coatings of the invention was manufactured.

### 2) Manufacture of Pretreatment Mixed Liquid 2

Glycerin 5%, Hydroxyl ethyl cellulose 2.5%, 5% Triton X-100 0.5% (brand name: manufactured by Union Carbide), Ammonium tartrate 2.5%, Purified water the balance.

By agitating the above substances and letting the agitated mixed liquid pass through a filter in the same method as in the above 1), a pretreatment liquid for the zinc coatings of the invention was manufactured.

### 3) Manufacture of Pretreatment Mixed Liquid 3

Glycerin 5%, Carboxyl methyl cellulose 1.5%, Urea 5% Triton X-100 0.5% (brand name: manufactured by Union Carbide), Citric acid 0.1%, Purified water the balance.

By agitating the above substances and letting the agitated mixed liquid pass through a filter in the same method as in the above 1), a pretreatment liquid for the zinc coatings was manufactured.

The antiviral compositions can be applied topically to the external surfaces of nonwoven web filaments after they are formed. Desirably, a uniform coating is applied over the substrate surfaces. A uniform coating refers to a layer of antiviral agents that does not aggregate only at selected sites on a substrate surface, but has a relatively homogeneous or even distribution over the treated substrate surface. Desirably, the processing aid should evaporate or flash off once the antiviral composition dries on the substrate surface. Suitable processing aids may include alcohols, such as hexanol or octanol. Note that the terms “surface treatment,” “surface modification,” and “topical treatment” refer to an application of the present antiviral formulations to a substrate and are used interchangeably, unless otherwise indicated.

Nonwoven fabrics that are treated with an antiviral coating of the present invention can be fabricated according to a number of processes. In an illustrative example, a method for preparing an anti-viral treated substrate involves providing a hydrophobic polymer substrate and exposing at least a portion of the substrate to a mixture that includes at least two anti-viral active agents and at least one co-active agent and at least one processing aid (e.g. alky-polyglycoside, or other surfactants). A suggested combination includes contacting the substrate with a mixture that includes an anti-viral agent, a wetting agent, a surfactant, and a rheology control agent. These components of the treatment composition may be combined in water mixture and applied as an aqueous treatment. The treatment composition may further include other components, such as anti-stats, skin care ingredients, anti-oxidants, vitamins, botanical extracts, scents, odor control agents, and color. The final amount of active reagents on the treated substrate may be diluted to a desired or predetermined concentration.

Additional surfactants that may be used include an anionic surfactant, a cationic surfactant, an ampholytic surfactant, or a nonionic surfactant. Examples of nonionic surfactants include polyethoxylates, fatty alcohols (e.g., ceteth-20 (a cetyl ether of polyethylene oxide having an average of about 20 ethylene oxide units) and other nonionic surfactants available from ICI Americas, Inc. (Wilmington, Del.)), cocamidopropyl betaine, alkyl phenols, fatty acid esters of sorbitol, sorbitan, or polyoxyethylene sorbitan. Suitable anionic surfactants include ammonium lauryl sulfate and lauryl ether sulfosuccinate. Preferred surfactants include lauroyl ethylenediamine triacetic acid sodium salt at a concentration between about 0.5-2.0%, Pluronic F87 at about 2.0%, Masil SF-19 (BASF) and incromide. Suitable concentrations of surfactant are between about 0.05% and 2%. Water used in the formulations described herein is preferably deionized water having a neutral pH. Alcohols that may be used according to the invention include but are not limited to ethanol and isopropyl alcohol.

According to an embodiment, the antiviral composition can be applied to the material substrate via conventional saturation processes such as a so-called “dip and squeeze” or “padding” technique. The “dip and squeeze” or “padding” process can coat both sides of and/or through the bulk of the substrate with the antiviral composition. When dipped in a bath, the antiviral solution be a unitary medium containing all components, or in subsequent multiple step processing, other desired components may be later added to the base antiviral layer. For instance, a formulation of an unitary antiviral solution may include leveling and/or antistatic agents. On substrates containing polypropylene, an antistatic agent can help dissipate static charge build-up from mechanical friction. An antistatic agent can be added to the antiviral solution, and the mixture can be introduced simultaneously to the material substrate in one application step. Alternatively, the antistatic solution can be applied using a spray after the antiviral solution in a second step.

In certain product forms, where one wishes to treat only a single side and not the inner layers or opposing side of the sheet substrate, in which the substrate material is layered to another sheet ply (e.g., filter or barrier media) that is without the antiviral treatment, other processes are preferred such as at rotary screen, reverse roll, Meyer-rod (or wire wound rod), Gravure, slot die, gap-coating, or other similar techniques, familiar to persons in the nonwoven textile industry. Also one may consider printing techniques such as flexographic or digital techniques. Alternatively one may use a combination of more than one coating to achieve a controlled placement of the treatment composition. Such combination may include, but not limited to, a reverse Gravure process followed by a Meyer rod process. Alternatively, the antiviral composition may be applied through an aerosol spray on the substrate surface. The spray apparatus can be employed to apply the antiviral solution and/or antistatic agent only on one side of the substrate sheet or on both sides separately if desired. An antistatic agent can be applied to the substrate in a secondary step, for example, using a spray system or any other conventional application process. On sheet materials, the treated nonwoven substrates can achieve at least a hydrostatic head greater than 20 millibars. Antiviral coatings are applied in as at least a single layer over SMS fabrics. Alternatively, one can use a melt extrusion process to incorporate an antiviral agent into the material followed by topical application of a second anti-microbial agent or co-active from an aqueous solution. Furthermore, other ingredients can also be added during the melt extrusion to enhance for example: a) wettability of the material if desired, b) electrical conductivity or anti-static properties, c) skin emollient, d) anti-oxidants, etc.

The choice of the coating process is dependent on a number of factors, which include, but are not limited to: 1) viscosity, 2) solution concentration or solids content, 3) the actual coating add-on on the substrate, 4) the surface profile of the substrate to be coated, etc. Often, the coating solution will require some formulation modifications of concentration (or solids content), viscosity, wettability or drying characteristics to optimize treatment or coating performance.

### Example LV

### Virucidal Assay

A summary of the procedure for the virucidal assay is listed below.

1) Reaction: Virus was added to Test Article and left for 60 minutes.

2) Termination: The reaction was terminated with infection media and virus solution was harvested from the filters.

3) Titration: The harvested virus was titrated 10-fold on MDCK cells across a 96 well plate.

4) Incubation: Cells were incubated for 3 days.

5) Endpoint determination: vCPE observation was made and HA was performed.

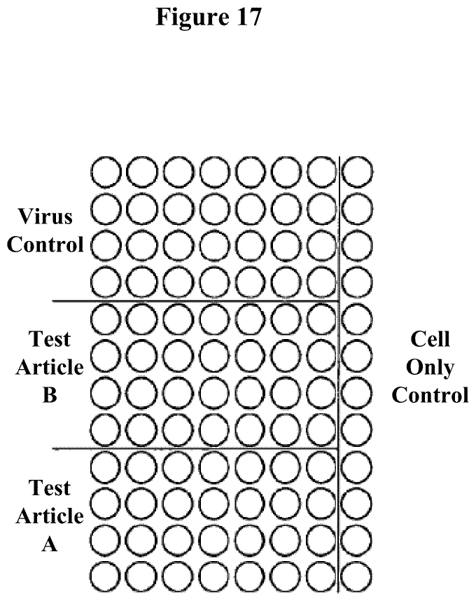

A typical plate layout of a 96-well plate as shown in FIG. 17 is used in the virucidal assay and cytotoxicity assay.

1) Cells were made up as above.

2) 200 μl of diluted Covid 2 virus at 1/10 (v/v) dilution in distilled water was added to each test or control article in a 6-well plate (in duplicate) and incubated at Room temperature on a shaker (at 300 MoT/minute) for 60 minutes. The reaction was stopped by addition of 1.8 ml of infection media. Virus solution was harvested into new wells in a 6-well plate.

3) In performing the procedure for the Citrate buffer control, 40 μl of virus at 1/10 (v/v) dilution in distilled water was added to 360 μl of Citrate buffer, pH 3.5 in a 7 ml bijou, the reaction was terminated after five minutes by the addition of 3.6 ml cell infection media.

4) The supernatant (111 μl) or virus only control (1/10 (v/v) dilution in infection media) was added to the first row of wells (MDCK cells in a 96-well plate). All supernatant and virus only controls were plated in quadruplicate and titrated 10-fold down the plate.

5) The plates were incubated at 37° C.+5% CO₂ for 1 hour. Then the plates were washed twice with PBS.

6) 100 μl of infection media was added to each well and plates incubated at 37° C.+5% CO₂ for 3 days.

7) On day 3 post-infection, the plates were scored for vCPE and HA was performed on the supernatants in accordance with Retroscreen Virology Ltd. SOP VA018-02. An observation for agglutination was made to confirm the presence of virus.

### Example LVI

### Demonstration of Virucidal Activity with Melt Blown Polypropylene Fabric Having Zinc Coating

Melt blown polypropylene having a weight basis of 3 oz/sq yd was first plasma treated (oxygen plasma for 1.5 min at 250 watts) in order to render it temporarily wettable to the coating reagents. Solutions of Example 4 were applied to the plasma treated fabric by soaking for a few minutes and then drying. Varying concentrations, application times, and conditions (e.g., solvent) were evaluated to optimize the coating. The fabric could also be coated without plasma pretreatment by prewetting the fabric with alcohol solution or with nonionic surfactant.

NCTC 929 (L929) cells are plated in wells of a 96-well plate at a concentration of 1×10⁴ cells/ml in 200 μA of media. Cultures are incubated for 3 hours at 37° C. in a 5% CO₂ environment in MEM supplemented with 10% fetal bovine serum, plus 100 μg/ml streptomycin, 100 units/ml penicillin and 250 ng/ml amphotericin B. VSV is thawed at 37° C. and diluted to 10⁻³ of the original stock concentration. The virus suspension (250 l) is pipetted in 10 μl increments onto 3 cm×3 cm pieces of fabric coated at 10 mg/ml with composition of Example 4. The pieces are covered in sterile 6-well tissue culture plates to prevent drying and allowed to incubate for 1 hour. Each sample is then washed with 2.25 ml of media and vortexed for 30 seconds in a sterile 50 ml centrifuge tube. Media is then squeezed out of the fabric samples, diluted serially and 200 μl is plated on eight replicate wells containing the established NCTC cells. After inoculation, the cells were cultured for 72 hours at 37° C. in 5% CO₂. The cells are scored for virus induced cytopathology and the Tissue Culture Infective Dose (TCID₅₀) is calculated. The viral titer from fabric with zinc is lower than that of the control fabric.

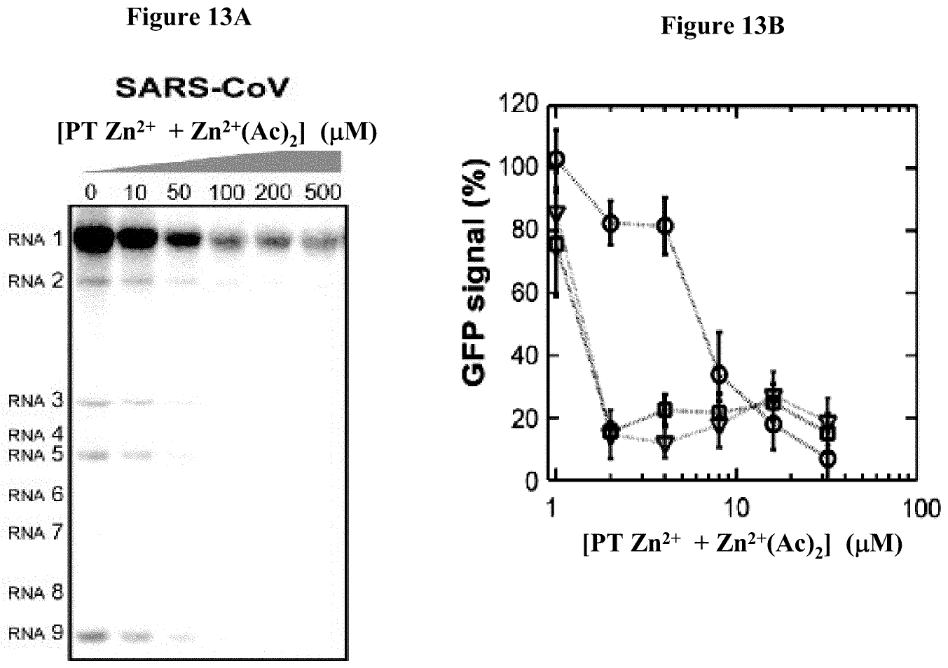

The zinc-ionophore pyrithione (PT) in combination with Zn²⁺ is a potent inhibitor of the replication of SARS-coronavirus (SARS-CoV) (See to Velthuis et al PLoS Pathog. 2010 November; 6(11): e1001176, the entire contents of which are incorporated by reference). Increasing the intracellular Zn²⁺ concentration with zinc-ionophores like pyrithione (PT) can efficiently impair the replication of a variety of RNA viruses, including poliovirus and influenza virus. For some viruses this effect has been attributed to interference with viral polyprotein processing. Te Velthuis et al demonstrated that the combination of Zn²⁺ and PT at low concentrations (2 μM Zn²⁺ and 2 μM PT) inhibits the replication of SARS-coronavirus (SARS-CoV) in cell culture. Using an activity assay for RTCs isolated from cells infected with SARS-CoV—thus eliminating the need for PT to transport Zn²⁺ across the plasma membrane—we show that Zn²⁺ efficiently inhibits the RNA-synthesizing activity of the RTCs of the virus. FIG. 13A shows the incorporation of [α-³²P]CMP into viral RNA SARS-CoV (B) in RTC assays in the presence of various Zn²⁺ concentrations, as indicated above each lane. FIG. 13B illustrates the effect of pyrithione (PT) and Zn²⁺ and zinc acetate on the GFP fluorescence in Vero-E6 cells infected with a GFP-expressing SARS-CoV reporter strain.

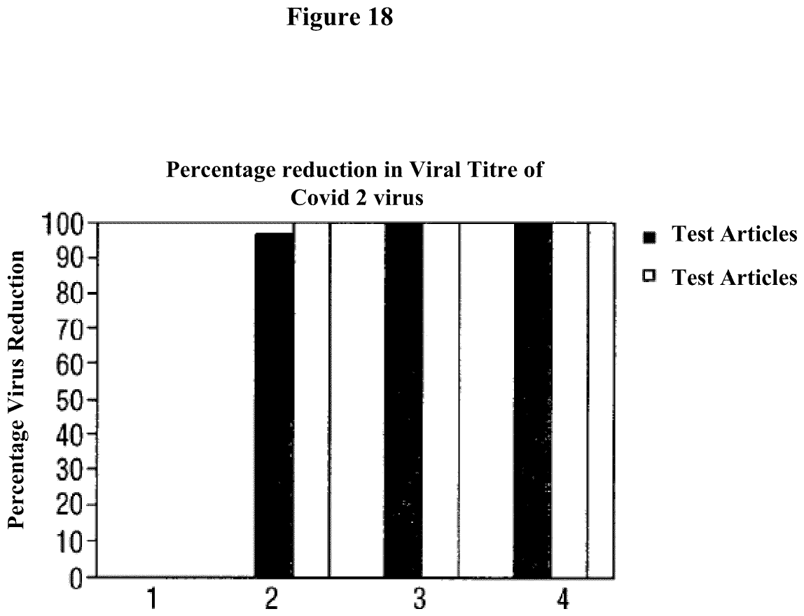

The SARS-CoV virus recovery, calculated percentage reduction following treatment with Test articles and Control article for 60 minutes is shown graphically in FIG. 18.

### Example LVII

### Multilayer Fabrics where Each Layer has Anti-Pathogenic Coatings

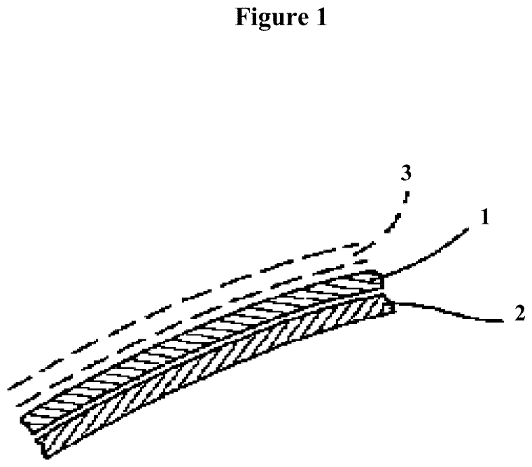

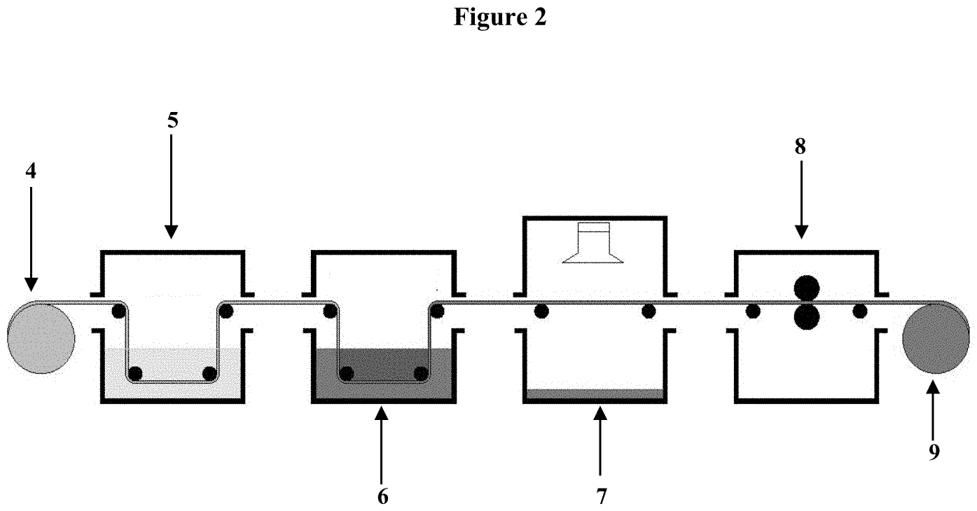

Referring to FIG. 1, this shows a suitable layered construction utilizing the filter fabric of the invention having 10-15% by weight of the antiviral compositions of the invention containing mixtures of zinc compounds. There is a layer 1 of the filter material containing the zinc compositions of the invention, an inner layer 2 of a non-woven polypropylene material which in use is against the user's skin containing 1-5% by weight of the compositions of the invention, and an optional outer layer 3, also of a non-woven polypropylene material also containing 5-10% by weight of the compositions of the invention. There may be plural layers 1, 2 and 3. The three layers contain the zinc compositions of the invention either in decreasing amounts from front to back, or vices versa and also the middle layer having the highest concentration by weight of the zinc compositions of the invention.

### Example LVII

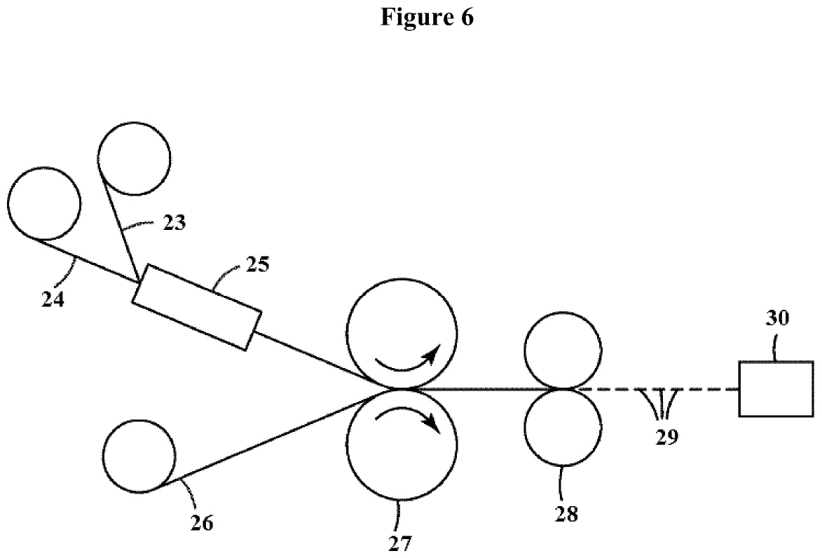

A mask is made according to the description of FIG. 6. In the illustrated embodiment, second web 23 and filtering web 24 which has been coated with the zinc compositions of the invention are together fed into a pleating station 25 where they are provided with a desired pleat configuration. Elastic web 26, which in some embodiments is intermittently cut in the machine direction, is joined to the filter web 24 and second web 23 in bonding station 27, which can employ any of the bonding methods described above. After bonding, the joined web is passed through a die cutting station 28 to provide individual face masks 29, which may be packaged as desired in stacking and packaging station 30. The second web 23 contains 5-10% by weight of the zinc compositions of the invention, web 24 contains 10-15% by weight of the zinc compositions of the invention and web 26 contains 1-5% by weight of the zinc compositions of the invention.

The zinc coated fabric substrates for use in preparing medical articles of the present invention can be provided in a variety of types and forms. Suitable substrates include porous materials capable of being fabricated into an article of choice.

Suitable zinc coated substrates include fabrics formed from textiles (e.g., knitted, woven or bonded fabrics) as well as nonwoven fabrics formed of fibers assembled in webs. Other porous materials, such as filters and membranes, are also suitable for use in preparing medical articles of the invention.

Zinc coated fabrics can be formed using conventional textiles, including cellulosics, cotton, synthetics, proteins, glasses, and blends. Woven fabrics can also be used and include such materials as cotton, polyester, nylon, acetate and wool.

Preferred zinc coated fabrics include nonwoven fabrics, such as webs made by processes such as melt blown, spun bond, spun laced and needle punching. Examples of preferred materials out of which nonwoven zinc coated fabrics can be made include polypropylene (PP), polyester (PES), rayon, nylon, acrylic, polyvinyl chloride (PVC), and blends thereof.

According to an additional embodiments of the present invention, there is provided a polypropylene-based fabric or polypropylene based material comprising a composition on either one surface or two surfaces. According to another embodiment of the present invention, there is provided a device that decreases the transmission of one or more than one human pathogen by antibacterial, antifungal and antiviral activity, where the device comprises a polypropylene-based fabric or polypropylene-based material coated with a composition according to the present invention. According to another embodiment of the present invention, there is provided a method of decreasing the transmission of one or more than one human pathogen, where the method comprises providing a device comprising a polypropylene-based fabric or polypropylene-based material coated with a composition according to the present invention, and using the device. In one embodiment, the device is a facial mask according to the present invention. In a particularly preferred embodiment, the device is a facial mask according to the present invention, where the body (and the flap when present) of the facial mask comprises three layers oriented from front to back, where Layer #1 comprises spunbond nonwoven polypropylene fiber having a density of 45 g/m² and coated with a composition according to the present invention comprising 2% citric acid, 2% polyethylene glycol (MW 600) and 0.5% polyoxyethylene (20) sorbitan, Layer #2 comprises spunbond nonwoven polypropylene fiber having a density of 45 g/m² and coated with a composition according to the present invention comprising 1% zinc pyrithione and 5% zinc acetate, and Layer #3 comprises spunbond nonwoven polypropylene fiber having a density of 25 g/m².

The zinc coatings of the invention may also include one or more anti-microbial or preservative agents, preferably at a total concentration between 0.05 and 5 weight percent or between 0.05 and 2 weight percent or between 0.1 and 2 weight percent. Examples of preferred anti-microbial and/or preservative agents include, but are not limited to, chlorhexidine gluconate (CHG), benzalkonium chloride (BZK), or iodopropynylbutyl carbamate (IPBC; Germall plus). Further examples of antimicrobial agents include, but are not limited to, iodophors, iodine, benzoic acid, dihydroacetic acid, propionic acid, sorbic acid, methyl paraben, ethyl paraben, propyl paraben, butyl paraben, cetrimide, quaternary ammonium compounds, including but not limited to benzethonium chloride (BZT), dequalinium chloride, biguanides such as chlorhexidine (including free base and salts (see below)), PHMB (polyhexamethylene biguanide), chlorocresol, chloroxylenol, benzyl alcohol, bronopol, chlorobutanol, ethanol, phenoxyethanol, phenylethyl alcohol, 2,4-dichlorobenzyl alcohol, thiomersal, clindamycin, erythromycin, benzoyl peroxide, mupirocin, bacitracin, polymyxin B, neomycin, triclosan, parachlorometaxylene, foscarnet, miconazole, fluconazole, itriconazole, ketoconazole, and pharmaceutically acceptable salts thereof.

Additional chlorhexidine salts that may be used as anti-microbial agents according to the invention include, but are not limited to, chlorhexidine palmitate, chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine di-propionate, chlorhexidine di-iodobutyrate, chlorhexidine di-n-valerate, chlorhexidine dicaproate, chlorhexidine malonate, chlorhexidine succinate, chlorhexidine malate, chlorhexidine tartrate, chlorhexidine dimonoglycolate, chlorhexidine monodiglycolate, chlorhexidine dilactate, chlorhexidine di-α-hydroxyisobutyrate, chlorhexidine diglucoheptonate, chlorhexidine di-isothionate, chlorhexidine dibenzoate, chlorhexidine dicinnamate, chlorhexidine dimandelate, chlorhexidine di-isophthalate, chlorhexidine di-2-hydroxynapthoate, and chlorhexidine embonate. Chlorhexidine free base is a further example of an antimicrobial agent.

Embodiments of the present antiviral composition may include a protective article, such as gloves, face masks, surgical or medical gowns, drapes, shoe covers, or fenestration covers. For purpose of illustration, the beneficial properties of the present invention can be embodied in a facemask containing a combination of one or more antiviral agents and co-active agents that rapidly inhibit and control the growth of a broad spectrum of viruses on the surface of the product both in the presence and absence of soil loading. The antiviral coating, which rapidly kills or inhibits, can be selectively placed on the exterior nonwoven facing of the mask rather than throughout the entire product. The antiviral agents are non-leaching from the surface of the mask in the presence of fluids, and/or are not recoverable on particles that may be shed by the mask in use and potentially inhaled by the user as measured using a blow-through test protocol.

Blow-through testing and analytical work produced evidence that the present antiviral combined solution treatment is safe for use with face masks and will not come off of the mask lining under normal use conditions. Using spunbond material samples treated with the present antiviral solution, we performed blow-through testing to simulate respiration for use in face mask products over an 8 hour period. The mask materials, including the treated spunbond samples, where compressed and held fixed between two funnels. Humidified air is blown through the funnel apparatus and any chemical treatment that may delaminate from the material is collected in a flask.

Referring to FIG. 1, this shows a suitable layered construction utilizing the filter fabric of the invention having the antiviral compositions of the invention containing mixtures of zinc compounds. There is a layer 1 of the filter material containing the zinc compositions of the invention, an inner layer 2 of a non-woven polypropylene material, which in use is against the user's skin, and an optional outer layer 3, also of a non-woven polypropylene material. There may be plural layers 1, 2 and 3.

Referring to FIG. 2 in more detail, it shows a non-woven roll of polypropylene fabric 4 which upon unwinding and entering receptacle 5 containing a primer and then dip coated in receptacle 6 having a solution of the zinc salt or combinations with other agents. After dip coating through receptacle 6, the fabric is dried by passing through mechanical drying chamber 7 and then allowed to dry in chamber 8 by natural evaporation of the solvent and then wound into final roll 9 for use as the filter fabric of the invention useful for making masks.

Referring to FIG. 2A, an exemplary process for application of a treatment composition of the present invention to one or both sides of a traveling web will be described. It should be appreciated by those skilled in the art that the invention is equally applicable to inline treatment or a separate, offline treatment step. Web 103, for example a spunbond or meltblown nonwoven or a spunbond-meltblown-spunbond (SMS) laminate, is directed under support roll 104 to a treating station including rotary spray heads 105 for application to one side 106 of web 103. An optional treating station 107 (shown in phantom) which may include rotary spray heads (not shown) can also be used to apply the same treatment composition or another treatment composition to opposite side 108 of web 103 directed over support rolls 109 and 110. Each treatment station receives a supply of treating liquid 111 from a reservoir (not shown). The treated web may then be dried if needed by passing over dryer cans (not shown) or other drying means and then under support roll 112 to be wound as a roll or converted to the use for which it is intended. For a polypropylene web, drying can be achieved by heating the treated web to a temperature from about 220° F. to 300° F., more desirably to a temperature from 270° F. to 290° F., by passage over heated drum to set the treatment composition and complete drying. Drying temperatures for other polymers will be apparent to those skilled in the art. Alternative drying means include ovens, through air dryers, infrared dryers, microwave dryers, air blowers, and so forth.

FIG. 2B illustrates an alternative arrangement and method of applying a treatment composition of the present invention. The alternative arrangement and method uses a saturation or dip and squeeze application step. As shown in FIG. 2B, web 113 which for example may be a 2.50 osy (ounce per square yard) bonded carded web of nonwoven surge material passes over guide roll 114 and into bath 115 that contains a mixture of the treating anti-viral composition in water. The treatment time can be controlled by guide rolls 116. The nip between squeeze rolls 117 removes excess treating composition which is returned to the bath by catch pan 118. Drying cans 119 remove remaining moisture. If more than one treatment composition is employed, the dip and squeeze may be repeated and the web 113 can be forwarded to and immersed in additional baths (not shown).

FIG. 3 describes a further embodiment of the invention illustrating coating the non-woven fabric using inkjet technology. A non-woven fabric roll 10 is unwinded and conveyed to entry point 11 and then further moved into the coating area having an inkjet printing head 12 and coating anti-viral solution 13 to provide an inkjet coating stream 13′ and the passing the coated fabric through drying tunnel 14 and convection removal location 15 and then passing the coated fabric through exit point 16 into a winding roller (not shown).

FIG. 3A shows a different perspective of ink jet printing according to the invention. The apparatus of FIG. 3A comprises a fabric feed roller 85 for feeding a fabric, a conveying roller 87, 87′ for conveying a fabric, a pretreatment head 82, a dryer 83, a printing head 84 and a control unit for controlling them respectively, and a winding roller 86 for winding and keeping the final printed fabric, wherein the pretreatment head 82, the dryer 83, the printing head 84 are arranged parallel to one another.

The fabric 81 fed by the fabric feed roller 85 is applied with a pretreatment liquid through the pretreatment head 82 consecutively as it is conveyed by the conveying roller 87, dried by the dryer 83, printed through the printing head 84, and re-winded and received by the winding roller 86. For application of the pretreatment liquid, the whole application method or the individual application method can be selectively used. The dryer is a device for enabling the pretreatment chemical to be rapidly dried as it is located between the pretreatment head 82 and the printing head 84. Drying methods include a microwave heating method, an infrared ray heating method, a heater heating method and the like, but they are not limited thereto. It can be constructed in a fixed type by fitting it to the width of the fabric or it can be constructed as a small device in a movable type enabling it to be reciprocally moved by fitting it to a small size.

As the pretreatment work is performed by using the inkjet device as described above, a continuous process gets to be available in the inkjet printing process.

The liquid composition for inkjet coating to be discharged by the control unit through controlling signals of the user's computer system gets to be varied depending upon materials or tissues, and the pick-up rate gets to be also varied. This individual application method is suitable in the case that different materials, such as silk, cotton, polyester, non-woven polypropylene and the like, are continuously inkjet-coated or printed. The individual pretreatment liquid composition can be also manufactured by mixing components thereof by a conventional method. The viscosity and surface tension thereof are respectively adjusted in the range of 2.0 cP˜20 cP and 30˜70 N/cm2 so that it may be made to be suitable for the currently commercialized inkjet head.

The surface tension and the viscosity as mentioned above are what were measured by the same instruments as used for the whole application method. This mixed pretreatment liquid is made to pass through a filter to remove any impurities and insoluble matters from it. Then, the pretreatment liquid is used.

The discharge, the non-discharge, the number of repetition times and the discharging amount of the individual pretreatment liquid can be set up by combining the number of respective cases by building up a database on suitable conditions thereof for each material and programming them. These characteristics of pretreatment for the inkjet printing are consistent with attributes of the textile printing for an unlimited number of materials.

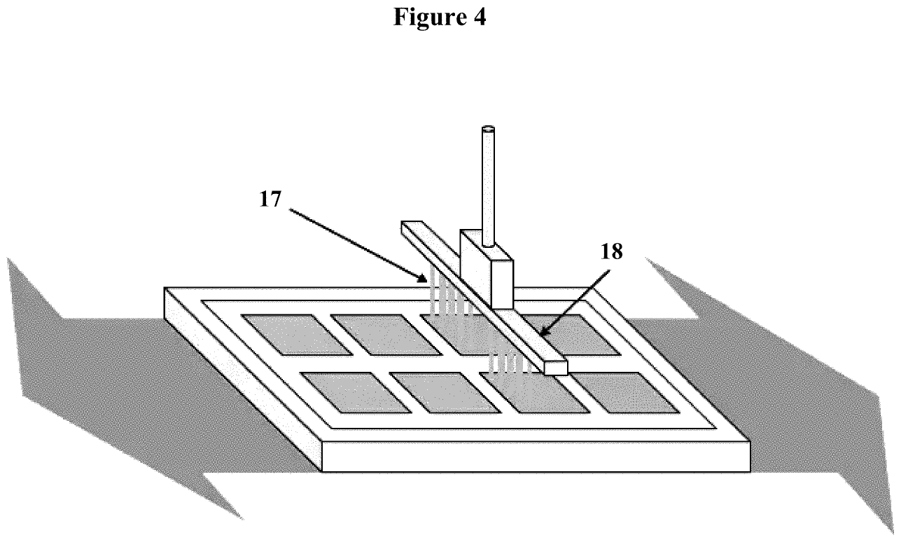

FIG. 4 shows a schematic of the inkjet coating with ink 17 with an inkjet print head 18.

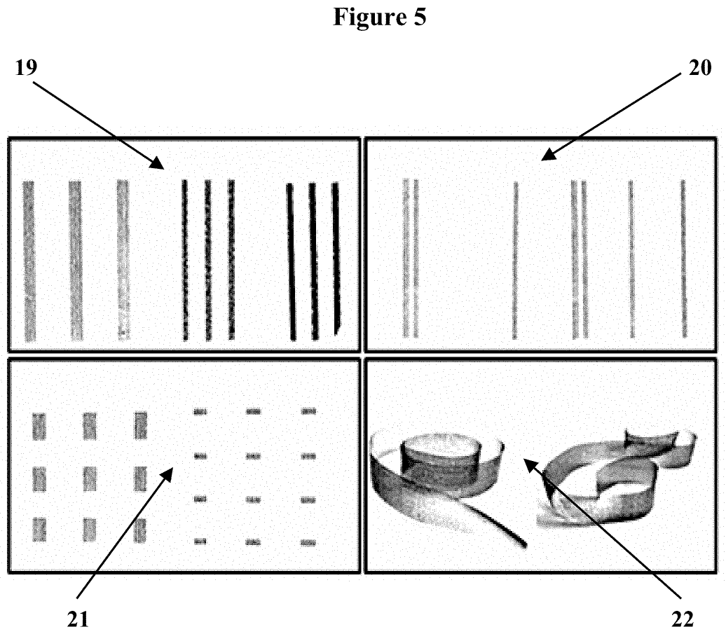

FIG. 5 shows the patterns that could be coated and printed on the non-woven fabrics where reference numeral 19 represents symmetric lines, reference numeral 20 represents asymmetric lines, reference numeral 21 illustrates different central printing dots and reference numeral 22 represents complete coating using inkjet printing.

A schematic illustration of an embodiment of a method of making a face mask according to the present disclosure is illustrated in FIG. 6. In the illustrated embodiment, second web 23 and filtering web 24 which has been coated with the zinc compositions of the invention are together fed into a pleating station 25 where they are provided with a desired pleat configuration. Elastic web 26, which in some embodiments is intermittently cut in the machine direction, is joined to the filter web 24 and second web 23 in bonding station 27, which can employ any of the bonding methods described above. After bonding, the joined web is passed through a die cutting station 28 to provide individual face masks 29, which may be packaged as desired in stacking and packaging station 30.

Another embodiment of the invention is illustrated in FIG. 7 which features laminating a nonwoven fabric 34 in front of the nonwoven fabric 32 or filter fabric 33 impregnated with the zinc containing compositions of the invention. Dust in the ambient air containing respiratory viruses is trapped by the nonwoven fabric 32 with breathing of the mask wearer, and the respiratory viruses are trapped and inactivated by the nonwoven fabric filter 33 impregnated with the zinc compositions of the invention, allowing the clean air alone to be sent into the mask wearer's lung. Presence of the nonwoven fabric 34 adds to the virus trapping performance of the antiviral mask 31, and the respiratory viruses are inactivated by the zinc compositions of the invention in the nonwoven fabric 32 or nonwoven fabric filter 33 disposed behind said nonwoven fabric 34. Thus, the respiratory viruses are prevented from entering the mask wearer's body while maintaining infectivity from the antiviral mask 31. When the nonwoven fabric 32 or nonwoven fabric filter 33 is impregnated with the zinc compositions of the invention, it is colored with the zinc compositions. Various types of filter, such as nonwoven filter fabric, high- or medium-performance filter, HEPA filter, etc., can be used as the white nonwoven fabric 34.

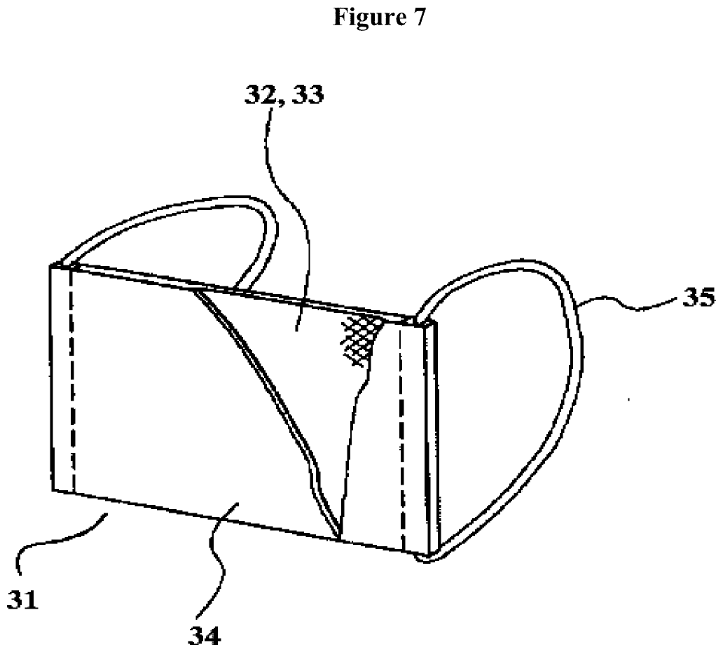

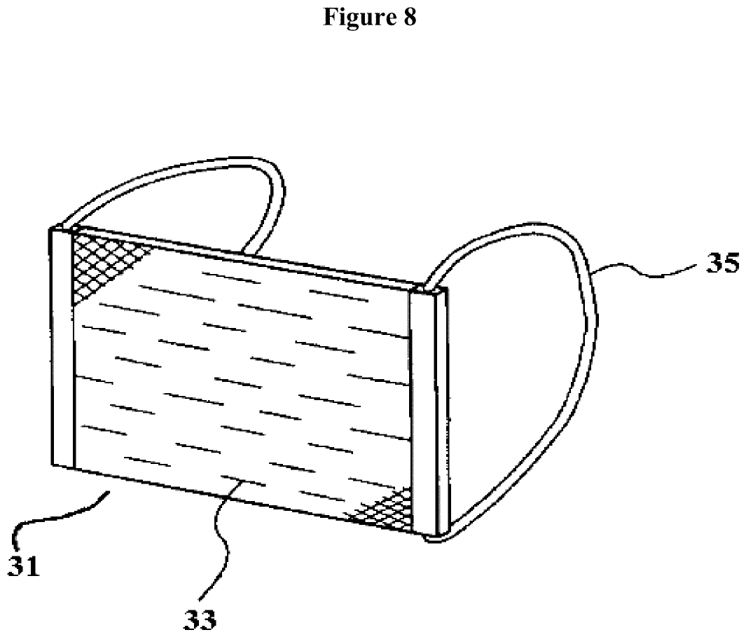

Another antiviral mask embodying the present invention is illustrated with reference to FIG. 8. In this and succeeding drawings, like reference numerals are used to indicate the parts identical with the conventional masks of this type, and no detailed explanation is given on such parts. The antiviral mask 31 of this embodiment consists of a nonwoven filter fabric 33 impregnated with the zinc containing compositions of the invention and a pair of strings 35 to be passed round the ears.

The nonwoven filter fabric 33 impregnated with the zinc containing compositions was obtained by dipping a nonwoven fabric in an aqueous solution containing 0.0001% by weight zinc pyrithione and 5% by weight zinc acetate, then lightly dehydrating and finally drying said fabric.

When you wear this antiviral mask 31, the ambient air containing the respiratory viruses is passed through the nonwoven filter fabric 33 impregnated with the zinc compositions as the mask wearer draws breath. The respiratory viruses carried in the air are captured by the nonwoven filter fabric 33 impregnated with the zinc compositions and thereby inactivated, allowing the clean air alone to be passed into the mask wearer's lung with breathing.

The respiratory viruses trapped by the nonwoven filter fabric 33 are inactivated by the zinc compositions impregnated in the fabric. Therefore, the trapped respiratory viruses are prevented from being rescattered while maintaining the infectious activity from the antiviral mask 31 and entering the mask wearer's system. The nonwoven filter fabric 33 may be replaced with a filter having an equal collecting performance, such as high- or medium-performance filter, HEPA filter, etc.

The nonwoven filter fabric 33 impregnated with the zinc compositions may be covered with another nonwoven fabric.

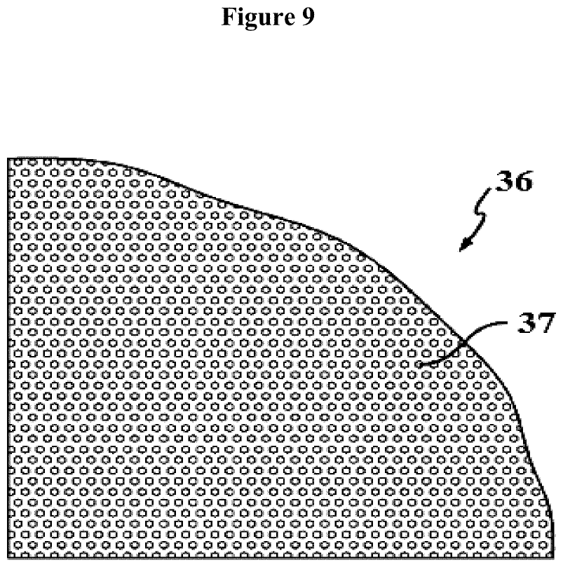

According to one further embodiment of the present invention, there is provided a fabric for decreasing the transmission of one or more than one human pathogens. Referring now to FIG. 9, there is shown a partial frontal perspective view of the fabric according to the present invention. As can be seen, in one embodiment, the filter fabric 36 according to the present invention comprises binding anti-pathogenic substances 37. In another embodiment, the filter fabric 36 according to the present invention includes a composition 37 for coating a polypropylene-based fabric or polypropylene-based material as disclosed in the instant application. In one embodiment, the fabric comprises spunbond polypropylene fiber. In one embodiment, the density of the spunbond polypropylene fiber is between 10 g/m² and 50 g/m². In a particularly preferred embodiment, the density of the spunbond polypropylene fiber is 25 g/m². In another particularly preferred embodiment, the density of the spunbond polypropylene fiber is 45 g/m².

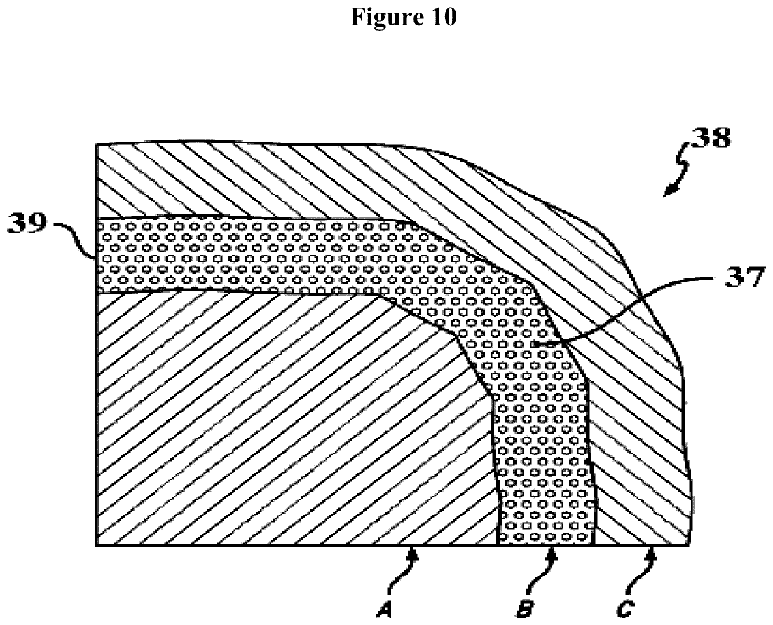

In another preferred embodiment, as shown in FIG. 10, the material 38 comprises three layers, a first layer of spunbond polypropylene fiber (layer A), a second layer of the filter fabric according to the present invention (layer B), and a third layer of melt-blown polypropylene fiber (layer C). In one embodiment, the density of the spunbond polypropylene fiber is between 10 g/m² and 50 g/m². In a particularly preferred embodiment, the density of the spunbond polypropylene fiber is 25 g/m². In another particularly preferred embodiment, the density of the spunbond polypropylene fiber is 45 g/m². In one embodiment, the density of the melt-blown polypropylene fiber is between 15 g/m² and 25 g/m². In a particularly preferred embodiment, the density of the melt-blown polypropylene fiber is 18 g/m². In a particularly preferred embodiment, as shown in FIG. 10, the material 38 comprises three layers, a first layer of spunbond polypropylene fiber (layer A) having a density of 45 g/m², a second layer of filter fabric according to the present invention (layer B), a third layer of spunbond/melt blown fiber composite (layer C) having a density of 18 g/m².

In one further embodiment, the fabric 39 according to the present invention comprises one or more than one pathogenic binding substances 37 that binds one or more than one type of human pathogen. In a preferred embodiment, the fabric 39 comprises one or more than one binding substance 37 that binds one or more than one type of virus, such as corona virus, that causes human respiratory tract infections such as Covid-2. By binding the human pathogen to the fabric 39 of the facial mask of the present invention, the fabric 39 decreases the transmission of the human pathogen, such as for example by preventing release of virus particles when virus-laden droplets evaporate within the fabric 39.

The one or more than one anti-pathogenic substances 37 comprises one or more than one human pathogen killing substance, as will be understood by those with skill in the art with reference to this disclosure. In a preferred embodiment, the killing anti-pathogenic substance 37 further comprises additives for attaching the substance 37 to the fabric 39.

By way of example, in one embodiment, the human pathogen to be removed or trapped or killed on fabric 39 is selected from the group consisting of adeno-associated virus (AAV), herpes simplex virus (HSV), human papillomavirus (HPV), coronaviruses, influenza viruses, rabies virus and respiratory syncytial virus (RSV).

As will be understood by those with skill in the art with reference to this disclosure, the anti-pathogenic substance 37 cannot render the fabric impermeable to gases when the fabric 39 is to be incorporated into the body of a facial mask according to the present invention because such impermeability would render the facial mask non-functional, as will be understood by those with skill in the art with reference to this disclosure.

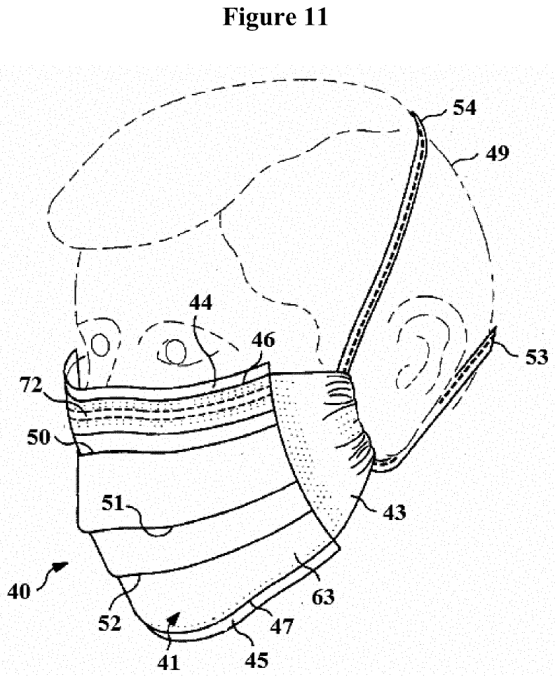

In another further embodiment, FIG. 11 shows a mask 40 incorporating the treated filter fabric of the present invention. Mask 40 includes filter body 41 having the composition of the invention with flaps 42 and 43 extending respectively from each side of filter body 41. As will be explained later in more detail, strips 44 and 45 of gasket-type sealing material may be disposed respectively adjacent to top edge 46 and bottom edge 47. Flaps 42 and 43 are preferably formed from fluid impervious material folded with a generally U-shaped cross section. Flaps 42 and 43 may sometimes be referred to as C-folds. For one application of the present invention, flaps 42 and 43 may be formed from polyethylene film laminated to a non-woven material. The non-woven material may also be hydroentangled. For other applications, the polyethylene film may be laminated to any type of material as desired. The polyethylene film layer may be color coded to correspond with different applications for using the resulting face mask.

Filter body 41, flaps 42 and 43, and strips 44 and 45 are preferably designed to prevent or retard the passage of liquids from the exterior of mask 40 to the face of wearer 49. It is extremely difficult to construct a mask that will fit the facial configuration of all wearers without constructing the mask specifically for each individual face. The use of strips 44 and 45 along with flaps 42 and 43 greatly increases the different sizes and types of faces which can be effectively protected by mask 40. Forming flaps 42 and 43 from suitable resilient or stretchable material further improves facial fit with a large number of wearers.

Filter body 41 may comprise a plurality of pleats 50, 51 and 52 which allow expansion of filter body 41 to cover the mouth and nose of wearer 49. The number of pleats 50, 51 and 52 formed in filter body 41 may be varied to provide the desired fit with the face of wearer 49. Pleat 50 is preferably folded in a reverse direction as compared to pleats 51 and 52. By providing reverse pleat 50, filter body 48 has an increased tendency to stand away from the face of wearer 49. The mask 40 includes ties 53 and 54 for securing the mask to the face.

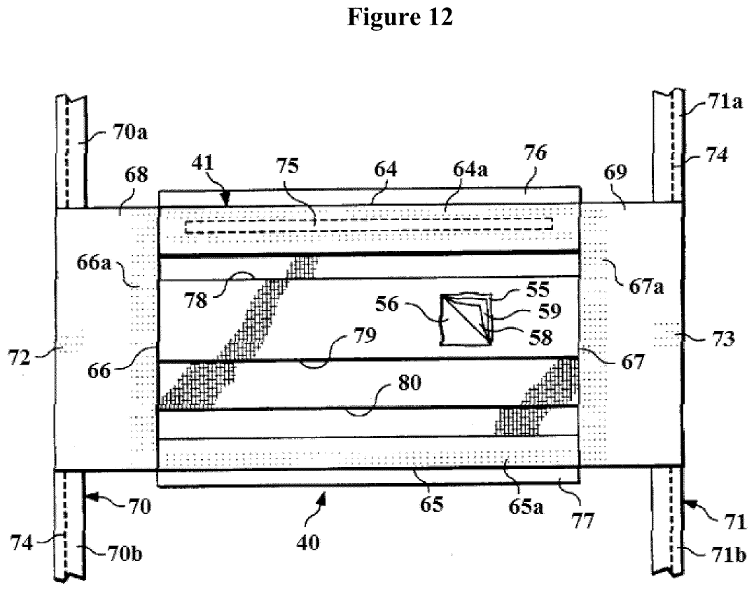

As shown in a further detailed embodiment by the cutaway portion of FIG. 12, filter body 41 includes four layers of material with an external surface of cover stock 55 as the outermost layer. Inner layer or internal surface 56 which contacts the face of wearer 49 may be constructed of a light weight, highly porous, softened, non-irritating, non-woven fabric. Inner layer 57 is designed to prevent unwanted materials such as facial hair, loose fibers or perspiration from contacting intermediate layers 58 and 59 which might cause a wicking effect to draw liquids through filter body 41. Inner layer 56 also provides a comfortable surface for contact with the face of wearer 49.

Intermediate layer 60 preferably comprises a barrier material that is capable of differentiating between gases and liquids and may be, for example, low density polyethylene. Non-wetting materials, such as used to form barrier material 60, have small apertures which prevent liquids with a relatively high surface tension from passing therethrough yet will allow gases with a low surface tension to pass therethrough. It is preferable to have the apertures as large as possible to allow easy breathing, and yet small enough to retard or prevent the flow of liquids. Intermediate layer 60 is designed to freely pass gases in either direction, while restricting the passage of liquids in at least on direction. Filter body 41 is constructed with barrier material 61 positioned to restrict liquid passage from the exterior of mask 40.

The next intermediate layer is preferably filtration media 62, which may be, for example, melt blown polypropylene or polyester. Filtration media 62 containing the zinc compositions of the invention is provided to inhibit the passage of airborne viruses in either direction which will prevent passage of germs to and from wearer 49. Outermost layer 63 provides the external surface for filter body 41, which may be treated, for example, by spraying with a liquid repellant to render the external surface material resistant to liquids.

Outer layer 63 and filtration media layer 62 serve as an aid to barrier material 58 by slowing down any liquid that may be splashed, sprayed or thrown at mask 40. By requiring the liquid to pass through layers 63 and 62 prior to reaching barrier material 60, the liquid will have less pressure and barrier material 60 will be better able to prevent passage of the liquid. Outer layer 63 may be formed from non-woven material such as cellulose fiber or from a polypropylene non-woven web.

Filter body 41 may be formed by bonding layers 63, 57, 58, and 62 with each other in a generally rectangular configuration. Such bonding is preferably provided along top edge 64, bottom edge 65 and lateral edges 66 and 67, respectively. The corresponding bonded areas 64a, 67a, 65a, and 66a may be formed by sewing, glue, heat sealing, welding, ultrasonic bonding and/or any other suitable bonding procedure.

Filter body 41 may comprise a plurality of pleats 78, 79 and 80 which allow expansion of filter body 41 to cover the mouth and nose of wearer 49. The number of pleats 78, 79 and 80 formed in filter body 41 may be varied to provide the desired fit with the face of wearer 49. Pleat 78 is preferably folded in a reverse direction as compared to pleats 79 and 80. By providing reverse pleat 78, filter body 41 has an increased tendency to stand away from the face of wearer 49.

Flaps 68 and 69 are preferably integrally attached to filter body 41 as part of the respective bonded areas 66a and 67a. Flaps 68 and 69 are preferably formed from fluid impervious material such as a plastic membrane and folded with a U-shaped configuration to form an opening to receive tie strips 70 and 71 therein. Bonded areas 72 and 73 are preferably used to secure the approximate mid-point of tie strips 70 and 71 with corresponding mid-points of flaps 68 and 69.

Top edge 64 of filter body 41 preferably includes an elongated malleable member 72 provided so that top edge 64 of filter body 41 can be configured to closely fit the contours of the nose and cheeks of wearer 49. Malleable member 75 is preferably constructed from an aluminum strip with a rectangular cross section, but may also be a molded or malleable steel or plastic member. Top edge 64, bottom edge 65a and flaps 68 and 69 cooperate with each other to define the periphery of mask 40 which contacts the face of wearer 49. Strips 76 and 77 along with flaps 68 and 69 substantially increase the area of contact with the face of wearer 49 as compared to a face mask having only tope edge 62, bottom edge 65 and lateral sides 66 and 67 in contact the face of wearer 49.

A single sonic stitch 74 is provided along the length of each surgical tie 70 and 71 to provide the desired longitudinal stretch and recovery capability. Single sonic stitch pattern 74 allows most of the material used to form surgical ties 70 and 71 to be open and free from the associated bonded area. Stitch pattern 74 allows surgical ties 70 and 71 to retain their naturally resilient characteristics.

Typically surgical style pleated face masks have a generally rectangular or square configuration of approximately 7×7 inches prior to pleating. The length and width dimensions of a typical face mask may vary by ±½ inches resulting in a face mask which is often rectangular in configuration as compared to a square. For some applications, the present invention allows reducing the length of top edge 64 from 7 inches to as short as 4½ to 5 inches. Alternatively, the present invention allows increasing the length of top edge 64 as desired. Also, the distance from top edge 64 to bottom edge 65 when mask 40 has been placed over the face of wearer 49 may be reduced from 7 to 5½ to 6 inches. Therefore, flaps 68 and 69, along with other features of the present invention allow reducing the total area of the filter media associated with mask 40 from approximately 49 square inches to 25 square inches to 30 square inches while maintaining approximately the same effective area. This reduction in area results in a substantial savings in the cost of materials used to fabricate mask 40 while, at the same time, maintaining good breathability, high efficiency filtration, and providing an improved seal between the periphery of mask 40 and the face of wearer 49 by incorporating strips 74 and 75.

The results of anti-viral effect are shown in FIGS. 13A and 13B. FIG. 13A features the incorporation of [α-³²P]CMP into viral RNA SARS-CoV (B) in RTC assays in the presence of various Zn²⁺ concentrations, as indicated above each lane, while FIG. 13B shows the effect of pyrithione (PT) and Zn²⁺ and zinc acetate on the GFP fluorescence in Vero-E6 cells infected with a GFP-expressing SARS-CoV reporter strain.

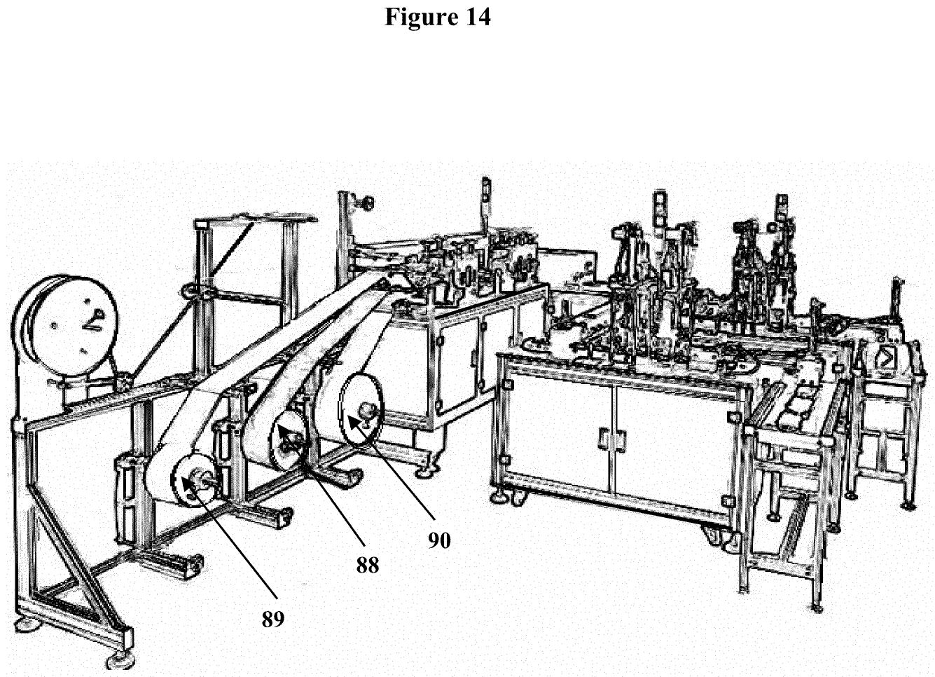

FIG. 14 shows a commercially available apparatus used to make masks using three rolls of fabrics wherein roll 88 is a non-woven polypropylene fabric which has been coated with the zinc compositions of the invention. The non-woven fabric fed from roll 88 is sandwiched between two other non-woven fabrics fed from rolls 89 and 90.

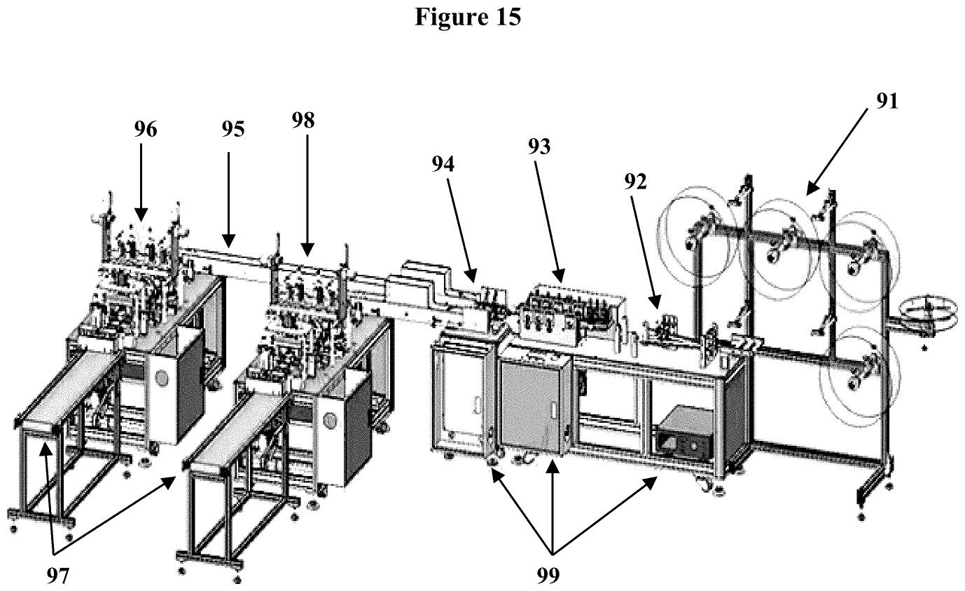

FIG. 15 is another commercially available fully automated apparatus for manufacturing masks which includes feeding web material rolls 91, a forming mechanism 92, a welding shaping mechanism 93, a connection agent 94, a transmission mechanism 95, two ear wire welding mechanisms 96 and 98, conveyor belts 97, and electric boxes 99.

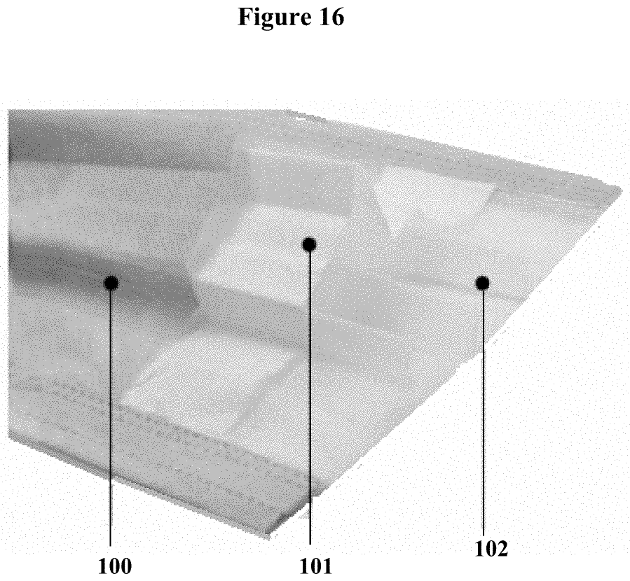

FIG. 16 is a cross section of a mask having a middle layer having the zinc compositions of the invention. The cross section of the mask shows an outer layer 100 for protection against liquid splashes, a middle filter layer 101 having the zinc compositions of the invention which acts as a barrier to stop viruses and an inner layer 102 which absorbs moisture and moisture released by the wearer.

FIG. 17 shows a typical 96-well plate layout for conducting the assays.

FIG. 18 shows graphically the percentage reduction in viral titer using the compositions of the invention.

The present invention can be used to prepare protective, e.g., medical, articles in a variety of shapes, styles, and sizes, and for protection against exposure to a variety of viruses.

Suitable medical articles include patient care articles such as wound and burn coverings, closures, and dressings, as well as surgical articles such as sterilizable instrument wraps, tapes, gowns, drapes, masks, wraps and sponges for use on or by a health care professional in the course of invasive surgery and similar procedures. Preferably the articles are sterilizable prior to use, and are often disposable after use. Other suitable articles include filters, membranes, and other similar products used for the preparation (e.g., purification) of products such as blood and its components.

All literature and similar materials cited in this application including, but not limited to, patents, patent applications, articles, books, treatises, and internet web pages, regardless of the format of such literature and similar materials, are expressly incorporated by reference in their entirety for any purpose as if they were entirely denoted. In the event that one or more of the incorporated literature and similar materials defines or uses a term in such a way that it contradicts that term's definition in this application, this application controls.

Although the foregoing description contains many specifics, these should not be construed as limiting the scope of the present invention, but merely as providing illustrations of some of the presently preferred embodiments. Similarly, other embodiments may be devised without departing from the spirit or scope of the present invention. Features from different embodiments may be employed in combination. The scope of the invention is, therefore, indicated and limited only by the appended claims and their legal equivalents rather than by the foregoing description. All additions, deletions and modifications to the invention as disclosed herein which fall within the meaning and scope of the claims are to be embraced thereby.

What is claimed is:

1. A composition for imparting anti-pathogenic properties to a breathable substrate material comprising:
(a) 0.0001-99.9999% by weight of a compound of the formula I 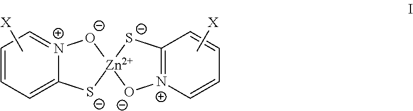
where X is a substituent at any carbon in the pyridine ring selected from the group consisting of H, C₁-C₅ alkyl, C₁-C₅ alkoxy, F, Cl, Br and I; and
(b) 0.0001-99.9999% by weight of an additional zinc salt selected from the group consisting of zinc acetate, zinc propionate, zinc oxalate, zinc benzoate, zinc gluconate, zinc ascorbate, zinc citrate, zinc lactate, zinc glycolate, zinc maleate, zinc fumarate, zinc picolinate, zinc propionate, zinc salicylate, zinc tartrate, zinc undecylenate, zinc salts of omega fatty acids, zinc glycinate, zinc polyacrylate, zinc polylactate, zinc polyglycolate and zinc polymaleate.

2. The composition according to claim 1, wherein the substituent X of the compound of formula I is H and component (b) is zinc acetate.

3. The composition according to claim 2, further including a solvent selected from the group consisting of water, ethanol, propanol, acetone and mixtures thereof.

4. The composition according to claim 3, further including a surfactant selected from the group anionic, cationic, zwitterionic and nonionic surfactants and mixtures thereof.

5. The composition according to claim 4, wherein said surfactant is a nonionic surfactant.

6. The composition according to claim 1, wherein said composition imparts anti-viral properties to the substrate.

7. A method of imparting anti-pathogenic properties to a face mask substrate material comprising:
(a) preparing a first coating composition containing a primer solution comprising a nonionic surfactant selected from the group consisting of Cetearyl Alcohol Ethoxylate 5-25 EO, Cetyl Alcohol Ethoxylate 2-20 EO, Cetyl Oleyl Alcohol Ethoxylate 2-30 EO, Lauryl Alcohol Ethoxylate 1-23 EO, Stearyl Alcohol Ethoxylate 2-20 EO, Isodecyl Alcohol Ethoxylate 3-8 EO, Isotridecyl Alcohol Ethoxylate 3-15 EO, C₉₋₁₁ Alcohol Ethoxylate 2.5-8 EO, Tallow Fatty Amine Ethoxylate 2-20 EO, Coconut Fatty Amine Ethoxylate 2-5 EO, Ditallow Amine Ethoxylate 15 EO, Castor Oil Ethoxylate 5-54 EO, Hydrogenated Castor Oil Ethoxylate 25-40 EO, Lauryl Alcohol Ethoxylated and Propoxylated, Ethoxylated Sorbitan Monolaurate 20-80 EO, Polyethylene Glycol 200-8000 MW, Glycerine Ethoxylate 26 EO, Nonylphenol Ethoxylate 4-100 EO and copolymers of ethylene oxide and propylene oxide, optionally 10 wt % by weight of a polyvinyl alcohol having a weight average molecular weight from about 50,000 Mw to about 250,000 Mw; and a solvent, and having a percent solids ranging from about 10 percent to about 50 percent;
(b) applying said first coating to a surface of a substrate;
(c) preparing a second coating composition comprising: (i) 0.0001-99.9999% by weight of a compound of the formula I 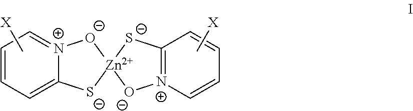
where X is a substituent at any carbon in the pyridine ring selected from the group consisting of H, C₁-C₅ alkyl, C₁-C₅ alkoxy, F, Cl, Br and I; and
(ii) 0.0001-99.9999% by weight of an additional zinc salt selected from the group consisting of zinc acetate, zinc propionate, zinc oxalate, zinc benzoate, zinc gluconate, zinc ascorbate, zinc citrate, zinc lactate, zinc glycolate, zinc maleate, zinc fumarate, zinc picolinate, zinc propionate, zinc salicylate, zinc tartrate, zinc undecylenate, zinc salts of omega fatty acids, zinc glycinate, zinc polyacrylate, zinc polylactate, zinc polyglycolate and zinc polymaleate; and wherein said coating composition comprising (a) and (b) has a solids content ranging from about 0.0001% percent to about 50% by weight;
(d) applying said second coating composition as a top coat over said first coating composition on said substrate; and
(e) drying the coated substrate material.

8. The method according to claim 7, wherein in said second coating composition the substituent X of the compound of formula I is H and component (b) is zinc acetate.

9. The method according to claim 8, wherein said second coating composition further includes a solvent selected from the group consisting of water, ethanol, propanol, acetone and mixtures thereof.

10. The method according to claim 9, wherein said second coating composition further includes a surfactant selected from the group anionic, cationic, zwitterionic and nonionic surfactants and mixtures thereof.

11. The method according to claim 10, wherein said surfactant is a nonionic surfactant.

12. The method of claim 7, wherein said coating is done by a method selected from the group consisting of spray coating, dip coating or inkjet coating.

13. The method according to claim 7, wherein said method imparts anti-viral properties to the substrate.

14. An air-permeable mask of a shape suitable to be placed over a user's mouth and nose and to sealingly contact the user's face, provided with means to hold the mask in place on the user's face, and comprising one or more layer of a filter material positioned such that inhaled and/or exhaled air of the user passes through the filter material, wherein the filter material comprises an air permeable substrate coated with the anti-pathogenic composition of claim 1.

15. The mask according to claim 14, wherein the air-permeable substrate comprises a fibrous substrate.

16. The mask according to claim 15, wherein the air-permeable substrate comprises a non-woven polypropylene.

17. A face mask, comprising: a body portion configured to be placed over a mouth and at least part of a nose of a user in such that respiration air is drawn through said body portion, wherein said body portion comprises an outer layer having incorporated the composition of claim 1, in an effective amount to impart anti-pathogenic properties.

18. A filter material suitable for use in a face mask comprising a fibrous substrate on which is deposited the composition of claim 1.

19. A composition for imparting anti-viral properties to a breathable substrate material comprising two or more zinc salts selected from the group consisting of zinc acetate, zinc propionate, zinc oxalate, zinc benzoate, zinc gluconate, zinc ascorbate, zinc citrate, zinc lactate, zinc glycolate, zinc maleate, zinc fumarate, zinc picolinate, zinc propionate, zinc salicylate, zinc tartrate, zinc undecylenate, zinc salts of omega fatty acids, zinc glycinate, zinc polyacrylate, zinc polylactate, zinc polyglycolate and zinc polymaleate said zinc salts being present in effective amounts to impart anti-pathogenic properties.

20. A polypropylene-based fabric coated with a composition according to claim 19.
